(19) United States
(12) Patent Application Publication
(10) Pub. No.: US 2003/0058806 A1
(43) Pub. Date: Mar. 27, 2003

(54) Multi-media communication system with advanced conference call management

(75) Inventors: Robert F. Meyerson, Naples, FL (US); Rodney A. Ross, Fairlawn, OH (US); Robert M. Nebiker, Naples, FL (US)

Correspondence Address: TIMOTHY P. O'HAGAN, 8710 KILKENNY CT, FORT MYERS, FL, 33912, US

(73) Assignee: Teleware, Inc., Akron, OH

(21) Appl. No.: 10/162,449

(22) Filed: Aug. 12, 2002

Related U.S. Application Data
(63) Continuation-in-part of application No. 09/961,532, filed on Sep. 24, 2001.
(63) Continuation-in-part of application No. 10/000,543, filed on Oct. 23, 2001.
(63) Continuation-in-part of application No. 10/081,513, filed on Feb. 21, 2002.

(51) Int. Cl. H04Q 11/00; H04L 12/16; H04L 12/28; H04L 12/56

(52) U.S. Cl. 370/260; 370/401

(57) ABSTRACT

A packet-switched data communication system includes a network interface configured to couple to a packet-switched network, a communication session module coupled to the network interface and configured to establish a communication session with a telecommunication device through the packet-switched network, a communication processing module coupled to the network interface and configured to receive real-time communication data, arrange the communication data in a sequence of packets, and send the sequence of packets to the network interface. Conference call capabilities include establishing multiple communication sessions between the communication session module and the telecommunication device.

### CROSS-REFERENCE TO RELATED ACTIONS

This application claims the benefit of, and is a continuation in part of U.S. patent application Ser. No. 10/081,513 filed on Feb. 22, 2002, entitled “Multi-Media Communication Management System with Enhanced Video Conference Services”, that is a continuation in part of U.S. patent application Ser. No. 10/000,543 filed on Oct. 23, 2001, entitled “Modular MultiMedia Communication Management System,” that is a continuation in part of U.S. patent application Ser. No. 09/961,532 entitled “Teledata Space and Docking Station with Modular and Integrated Display” filed on Sep. 24, 2001, the contents of both such patent applications being incorporated herein.

### FIELD OF THE INVENTION

The invention relates generally to managing multi-media communications, and more particularly to a modular system for managing conference communications.

### BACKGROUND OF THE INVENTION

Multi party calls or conference calls have provided a convenient method for enabling remotely located individuals to orally participate in a meeting. Many existing PBX systems enable the operator of a desk top telephone to place calls to multiple parties and conference the multiple parties together. The PBX establishes a circuit switched connection with each participant (whether on the public switched telephone network (PSTN) or the private network controlled by the PBX) and then bridges the lines together.

One problem associated with such a system is that the operator of the desk top phone must initiate the conference call by dialing each participant and using an appropriate conference button(s) and/or a hold button(s) to bring all participants together. Such a process is time consuming at best. And, if an operator is not familiar with the telephone system, such a process may require reliance on a manual to properly activate the correct button sequences to dial each participant to initiate the call.

Another problem associated with such systems is that audio quality degrades when participants are added. The voice volume of each participant may be unequal and background noise from each line is aggregated into the conference. Typically audio quality becomes unacceptable when greater than three participants are connected.

More recently conferencing bridge systems have been developed to improve conference call quality. Typically each participant will dial into a conferencing bridge and enter a pass code to join a conference. The conferencing bridge includes signal processing circuits for reducing background noise, echo cancellation, and balancing the volume of different speakers.

A problem with conferencing bridge systems is that the conference call must be scheduled with the bridge and each caller must call into the bridge. Therefore, if the operator of a desk top telephone desires to set up a conference call with four participants, the operator must first schedule a call with the bridge and set a pass code for participants to use when calling into the bridge. Secondly, the operator must notify each participant of the dial-in number to the bridge and the pass code to enter the conference. This is at least as cumbersome as dialing all four participants and utilizing the PBX for the conference.

Another problem associated with both the PBX system and the bridge system is that there exists no convenient system for monitoring participation in the conference call. In the bridge system, a participant could manually track entries and departures based on the system notifications, manually tracking entries and departures to determine who is participating in the call at any given time is subject to error, distracting, and cumbersome.

Yet another problem associated with the known conferencing systems is that they do not provide a system for two or more remote participants to converse in private such that they can hear each other but can not be heard by the other participants.

What is needed is a multi media communication management system that provides audio and video conferencing services that does not suffer the disadvantages of the existing communication systems.

### SUMMARY OF THE INVENTION

In one aspect, the present invention provides an audio communication device for interfacing with a conference mixer. To provide conference calling for wireless devices, the audio communication device includes a means for establishing a first audio session with the conference mixer to support a first participation in a conference call; and a means for establishing a second audio session with the conference mixer to support wireless session in said conference call.

In another aspect, the present invention provides a communication management system for joining a wireless audio session supported by a wireless communication device into a conference call. In this aspect a control module is adapted to couple a plurality of local communication devices in communication on a local network to a plurality of remote communication devices over an external network. A subscriber station comprising a control unit is adapted to initiate a conference call between the local communication devices and the remote communication devices and further adapted to conference in a wireless communication device into the conference call.

The present invention also provides a conference call method. The method includes the steps of establishing a first audio session between a first and second participant; detecting a wireless communications device; and establishing a second audio session between the wireless communication device and the first or second participant.

In all the embodiments, the session can be a VIOP session or a circuit switched session to support a wide variety of wireless communication devices.

These and other advantages of the invention, along with the invention itself, will be more fully understood after a review of the following figures, detailed description, and claims.

### BRIEF DESCRIPTION OF THE FIGURES

FIG. 1 is a block diagram view of a modular multi-media communication management system in accordance with one embodiment of the present invention;

FIG. 2 is a block diagram of a multi-media communication management system controller in accordance with one embodiment of the present invention;

FIG. 3 is a perspective exploded view of a modular subscriber station in accordance with one embodiment of the present invention;

FIG. 4 is a block diagram of a subscriber station in accordance with one embodiment of the present invention;

FIG. 5 is a block diagram of a subscriber data assistant in accordance with one embodiment of the present invention;

FIG. 6 is a block diagram of a wide area network communication device in accordance with one embodiment of the present invention;

FIG. 7 is a block diagram of a wireless dialog handset in accordance with one embodiment of the present invention;

FIG. 8a is a table diagram representing a current network location table in accordance with one embodiment of the present invention;

FIG. 8b is a table diagram representing a multicast group table in accordance with one embodiment of the present invention;

FIGS. 9a through 9j each show a flow chart representing processing steps performed by a multi-media communication management system in accordance with one embodiment of the present invention;

FIGS. 10a through 10f each show an exemplary display of information to a subscriber utilizing a subscriber interface of a subscriber station in accordance with one embodiment of the present invention; and

FIGS. 11a through 11c each show a flow chart representing exemplary operation of packet audio/video gateway in accordance with one embodiment of the present invention.

### DETAILED DESCRIPTION OF PREFERRED EMBODIMENTS

The present invention is now described in detail with reference to the drawings. In the drawings, each element with a reference number is similar to other elements with the same reference number independent of any letter designation following the reference number.

It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

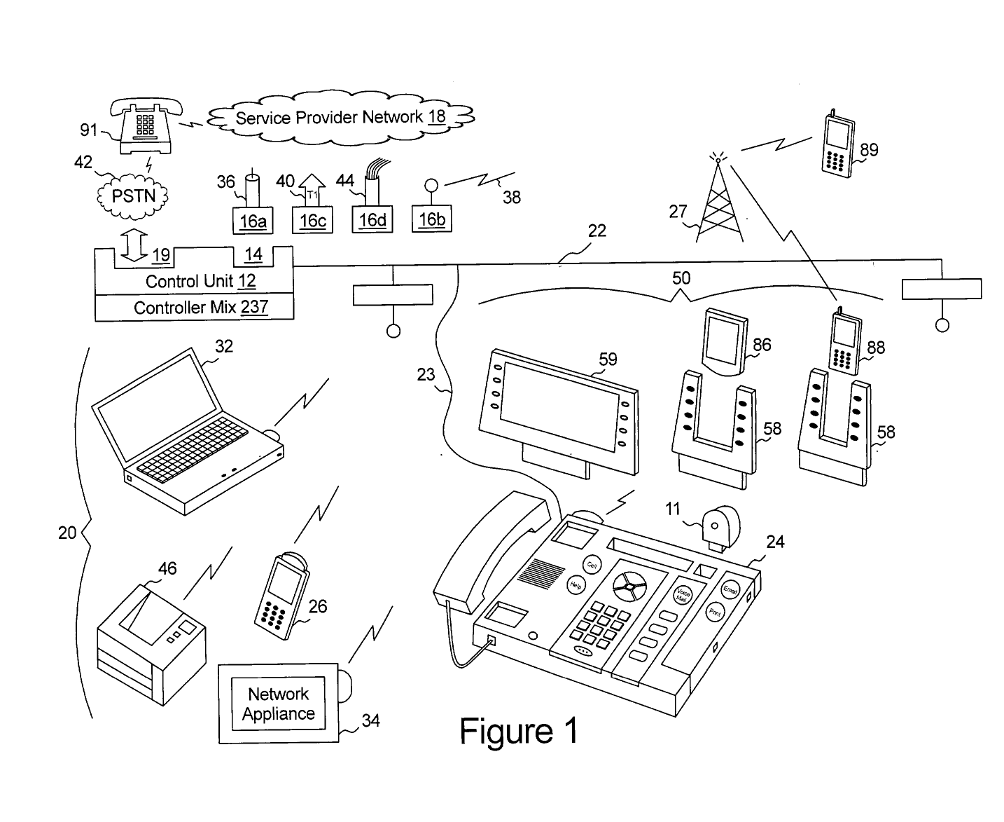

Referring to FIG. 1, an exemplary architecture of the multi-media communication management system 10 of the present invention is shown. The multi-media communication management system 10 includes a control unit 12 that is coupled with a plurality of local communication devices 20 over a wireless local area network 22 (or by a wired network connection 23 to the backbone wired network of the wireless local area network 22). The local communication devices 20 may include: subscriber stations 24 (subscriber stations 24), wireless dialog handsets 26, traditional computer systems 32, network printers 46, and various network appliances 34.

The control unit 12 includes a circuit-switched provider bay 19 which operatively couples the control unit 12 to the public switched telephone network (PSTN) 42 and includes a multimedia communication service provider bay 14 which operatively couples the control unit 12 to a multi media service provider's network 18 through one of a plurality of communication medium modules 16a-16d.

In the exemplary embodiment, the service provider's multi-media communication network 18 may utilize the Internet Protocol Suite for communication at the IP level, but may be proprietary at the data link and physical layers. As such, the control unit 12 includes the IP stacks applicable for communication between applications over the network 18 and each module 16a-16d includes the applicable data link and physical layer circuits for communication of IP frames over the physical medium of the network 18.

Some illustrative examples of communication modules include: communication module 16a which may be a cable modem module for communicating over coaxial cable 36 with a multimedia communication service provider such as a local cable company, communication module 16b which may be a wide area network radio for communication over a wireless spectrum channel 38 with a wide area wireless multi-media communication service provider such as an analog or digital cellular/PCS telephone service provider, communication module 16c which may be a customer service unit (CSU) for communication over a T1 line 40 with a multi-media communication provider such as a local telephone service provider, and communication module 16d which may be an optical modem for communication over a fiber channel 44 with a fiber optic multi-media communication service provider.

In operation, the control unit 12 integrates and manages multi-media communication between two or more local communication devices 20 and between each local communication device 20 and a remote communication system(s) (not shown) coupled to either the service provider's multi-media communication network 18 or the PSTN 42.

As part of integrating and managing multi-media communications, the control unit 12 includes a conference server mix module 237 for supporting conference calls among multiple subscriber stations 24 and multiple remote telecommunication devices 91 coupled to either the PSTN 42 or the service provider network 18. Each subscriber station 24 and remote telecommunication device 91 participating in the conference call establishes a communication session (either a VOIP session over the network 22 or the service provider network 18) or a PSTN session over the PSTN 42 with the control unit 12.

The subscriber station 24 further provides for joining a wireless caller (using a remote wireless telephone 89) into a conference call. More specifically, when a wireless call is in session between the remote wireless telephone and the subscriber's wireless telephone 88, the subscriber's wireless telephone 88 may be placed docked to the subscriber station 24. Once docked to the subscriber station 24, the subscriber station 24 establishes a communication link with the subscriber's wireless telephone 88 such that the wireless call is interfaced to the subscriber station 24. Upon activation of the cell button on the face of the subscriber station 24, the subscriber station will initiate an additional VOIP communication session with the control unit 12 module and relay audio between the wireless telephone 88 and the control unit 12 such that the remote wireless telephone 89 is effectively participating in the conference call.

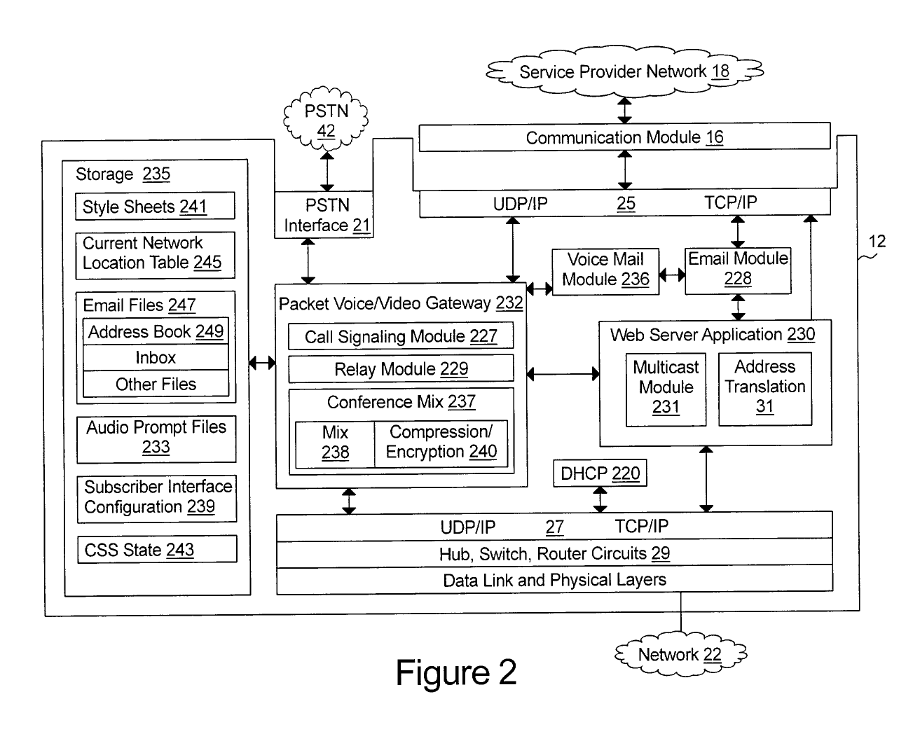

FIG. 2 shows a block diagram of an exemplary control unit 12. The control unit 12 includes applicable modules for managing the local area network 22 as an IP network. Such modules may include an applicable combination of hubs, routers, and switches 29 for managing communications over the network 22 as well as an address server 220 (e.g. DHCP server) for assigning local IP addresses to each local communication device 20.

The control unit 12 may also include a packet audio/video gateway 232, a voice mail module 236, an email module 228, and a web server application 230.

Packet Voice Gateway

The packet audio/video gateway 232 provides a subscriber's real time full duplex audio and audio/video call and conference call services. The services may include routing and maintaining a subscriber's outgoing calls, a subscriber's incoming calls, and a subscriber's conference calls.

A subscriber's outgoing calls are calls initiated by the subscriber utilizing a subscriber station 24. A subscriber's incoming calls are calls initiated by a remote caller to the subscriber.

Each call takes place over a real time communication session between the subscriber station 24 serving the subscriber and a remote device serving the other call participant. The remote device may be another subscriber station 24, a packet audio/video device coupled to the service provider network 18, or a PSTN device coupled to the PSTN 42.

A real time communication session between the subscriber station 24 and another subscriber station 24 or a packet audio/video device coupled to the service provider network 18 will be a VOIP session with the subscriber station 24 being one endpoint of the VOIP session and the other subscriber station 24 or the packet audio/video device being the other endpoint.

A real time communication session between a subscriber station 24 and a PSTN device coupled to the PSTN 42 comprises a VOIP session between the subscriber station 24 and the gateway 232 plus a PSTN session between the gateway 232 and the PSTN device. In this case, the subscriber station 24 and the gateway 232 are the two endpoints of the VOIP session and the gateway 232 and the PSTN device are the two PSTN endpoints of the PSTN session.

Establishing and managing a VOIP session between two endpoints includes exchanging session signaling messages, channel negotiation messages, compression capability messages, and optionally encryption capability and key messages between the two endpoints utilizing predetermined message protocols such as the Session Initiation Protocols (SIP) established by the Internet Engineering Task Force (IETF). The messages are exchanged utilizing UDP/IP datagrams transferred between the two endpoints over the network 22 and the service provider network 18. The gateway 232 operates as an address directory for locating an endpoint on the local area network 22 and as an IP layer proxy for exchanging datagrams between the two endpoints.

After a VOIP session is established, communication of audio (and video) data between the two endpoints comprises compressing digital audio data into a sequence of RTP frames, optionally encrypting the RTP frames, and sending the RTP frames to the other endpoint utilizing UDP/IP datagrams on the negotiated channels. At the other endpoint, the UDP/IP datagrams are received, sequenced, and the RTP frames are recovered, decrypted if applicable, and decompressed to yield the digital audio data.

Establishing a PSTN session between two PSTN endpoints includes use of standard PSTN analog or PSTN digital signaling and, after the PSTN session is established, communication of audio data between the two PSTN endpoints comprises standard PSTN analog or PSTN digital communications.

A multi-party conference call initiated by the subscriber to a plurality of callee participants comprises a VOIP session between the subscriber station 24 supporting the subscriber and the gateway 232 plus a plurality of participant sessions. These participant sessions are VOIP sessions and/or PSTN sessions, each between the gateway 232 and a participating subscriber station 24, packet audio/video device coupled to the network 18, or PSTN device coupled to the PSTN 42.

The gateway 232 comprises a PSTN interface module 19, a call signaling module 227, a relay module 229, a conference mix module 237, and a compression/encryption module 240.

The PSTN interface module 21 includes circuits for translating between PSTN session signaling (and analog or PSTN digital audio communication) and digital session signaling messages (and digital audio communication formats and protocols) for use by the other elements of the packet audio/video gateway 232.

The call signaling module 227 includes a routing circuit, a session signaling circuit, and a directory circuit that work in combination to provide: i) routing of a subscriber's incoming calls to a subscriber station 24 that is then serving the subscriber or to voice mail; ii) routing the subscriber's outgoing calls to another subscriber station 24, a packet audio/video device on the network 18, or to a PSTN destination; and iii) establishing calls between the gateway 232 and each conference participant. The routing circuit provides for routing session signaling messages between the two VOIP endpoints when the gateway 232 itself is not one of the endpoints. The session signaling circuit generates session signaling messages and establishes a VOIP session on behalf of the gateway 232 if the gateway 232 is an endpoint of the VOIP session being established (e.g. a session between a subscriber station 24 and a PSTN device or a conference call including the subscriber station 24).

With respect to a subscriber's outbound calls (and with respect to a subscriber's conference calls), the directory receives session signaling messages, from the subscriber's subscriber station 24 (or from the conference mix module 237 if a conference call) and that includes a number identifying the callee, and routes the call to the callee. The number identifying the callee may be a 10 digit number representing a subscriber loop of the PSTN 42, a number identifying a person operating a packet audio/video device coupled to the network 18, or a subscriber ID representing a subscriber to the system 10.

If the number represents a packet audio/video device coupled to the network 18, the number may be permanently assigned to the device. The IP network address utilized by the device, however, may change periodically. As such, the directory circuit may query a remote directory server to determine the network address of the device (or the network address of a proxy for the device) and provide the network address to the subscriber station 24 such that it may initiate session signaling directly to the device or the proxy.

If the number represents a subscriber loop of the PSTN 42, the directory circuit provides the number to the PSTN interface 21, such that the PSTN interface circuit may establish a PSTN session with a PSTN device coupled to the subscriber loop. The director circuit also instructs the call signaling module 227 to respond to the call signaling to establish a VOIP session between the subscriber station 24 and the gateway 232.

If the destination device is a subscriber to the system 10, steps discussed below with respect to receiving an inbound call for a subscriber are applicable.

With respect to a subscriber's inbound calls, the directory circuit receives session signaling messages from a caller device that identifies a subscriber as the callee, and routes the call to the particular subscriber station 24 that is then servicing the subscriber or, if the subscriber is not served by a subscriber station 24 or is already participating in a call, routes the call to the voice mail module 236 such that the caller may leave a message for the subscriber.

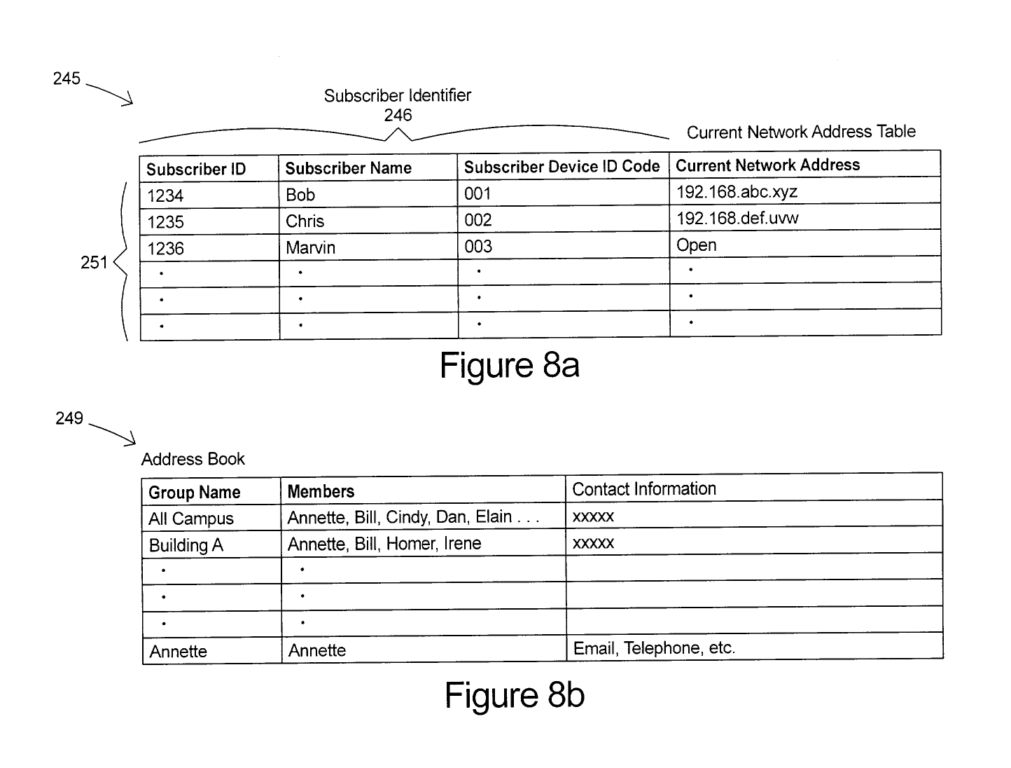

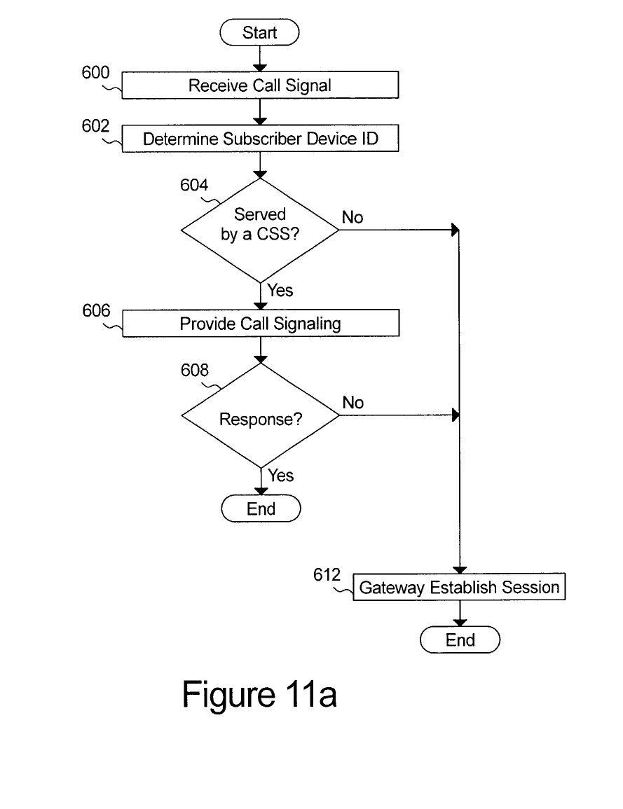

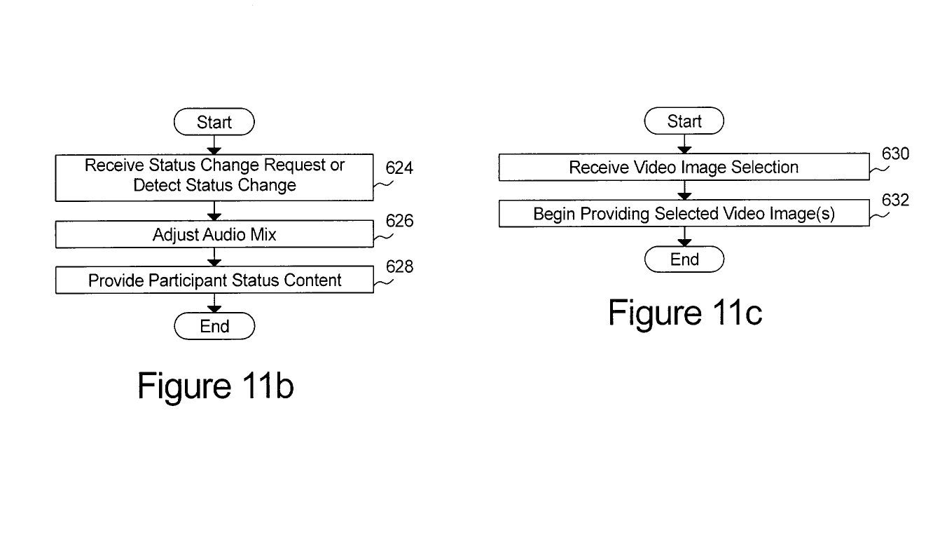

Referring to FIG. 11a in conjunction with the current network location table 245 of FIG. 8a, the process of identifying the subscriber station 24 servicing the subscriber is shown.

Step 600 represents receipt of the session signaling message identifying the subscriber. In the exemplary embodiment, each subscriber will be assigned a four digit subscriber identifier number that corresponds to the last four digits of a PSTN direct dial number that routes to the PSTN interface 21 when dialed on the PSTN. As such, the session signaling message, whether originated by a packet audio/video device coupled to network 18, a subscriber station 24 coupled to the network 22, or the PSTN interface 21 (in response to PSTN session signaling), may include the subscriber identifier number to identify the destination subscriber.

At step 602, the directory circuit identifies a subscriber device 50 (FIG. 1) that is associated with the identified subscriber utilizing the network location table 245. To associate each subscriber with his or her subscriber device 50, the network location table 245 includes a record for each subscriber. Within such record is a field that identifies the subscriber, identifies the four digit subscriber identifier associated with the subscriber, and identifies a subscriber device ID code that is unique to the subscriber device 50 that is assigned to the subscriber.

At step 604 the directory circuit identifies whether the subscriber's subscriber device 50 is served by a subscriber station 24. The network location table 245 further includes a field that may comprise the network address of the subscriber station 24 that is then currently serving the subscriber device 50 assigned to the subscriber. The address within this field will be updated when the subscriber moves his or her subscriber device 50 from one subscriber station 24 to another using circuits and methods discussed herein. If the subscriber device 50 is not currently served by any subscriber station 24, then the field will indicate such as represented by the term “open”.

If at step 604, the directory circuit determines that the subscriber device 50 assigned to the subscriber is not currently served by any subscriber station 24, the directory circuit instructs the call signaling module 227 to establish the session on behalf of the gateway 232 such that the caller will be coupled to the voice mail module 236 at step 612.

If the subscriber device is served by a subscriber station 24, however, the directory circuit at step 606 either: i) provides the network address of the subscriber station 24 to the caller device if the caller device is coupled to the local area network 22; ii) instructs the routing circuit to send the call signaling messages to the subscriber station 24 if the caller device is a packet audio/video device coupled to the network 18; or iii) instructs the session signaling circuit to respond to the session signaling and establish a VOIP session with the subscriber station if the caller device is coupled to the PSTN 42.

Step 608 represents the directory circuit determining whether the subscriber station 24 is responding to the session signaling provided by either the routing circuit or the session signaling circuit at step 606. In certain events such as when the subscriber is already engaged in a call or if the subscriber does not answer the inbound call, the subscriber station 24 will not respond to the session signaling. In this case, the directory circuit instructs the call signaling module 227 to establish the session on behalf of the gateway 232 such that the caller will be coupled to the voice mail module 236 at step 612.

The relay module 229 includes circuits for operating as an IP layer proxy for VOIP sessions between a subscriber station 24 endpoint and a packet audio/video device coupled to the network 18 endpoint.

The compression/encryption module 240 performs the translation between digital audio data and compressed RTP frames, that may be encrypted, for VOIP sessions for which the gateway 232 is itself an endpoint (e.g. sessions between a subscriber station 24 and a PSTN device and sessions between the gateway 232 and each conference participant).

The conference mix module 237 includes an audio mixing circuit, a video routing circuit, and a conference session control circuit. The audio mixing circuit receives audio streams from each participating endpoint in the form of digital audio data provided by the compression/encryption module 240 or the PSTN interface 21 and generates digital audio data comprising one or more conference mix audio streams. The conference mix module 237 provides applicable conference mix audio streams back to each participating endpoint. It is undesirable to include the voice of a participant in the conference mix audio stream that will be returned back to such participant's endpoint because echoes could occur. As such, a single conference call may require multiple conference mix audio streams—one for each participant that excludes such participant's own voice.

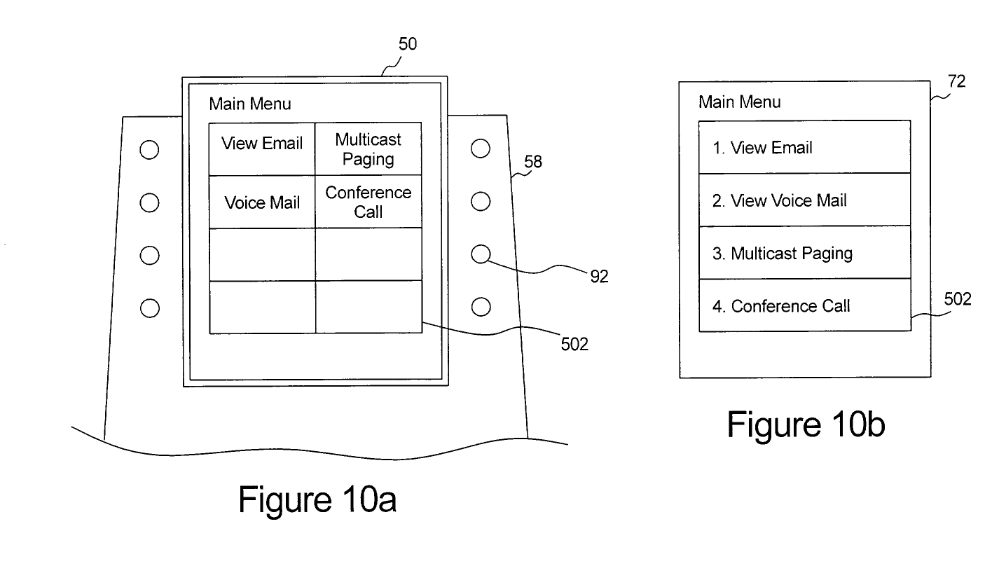

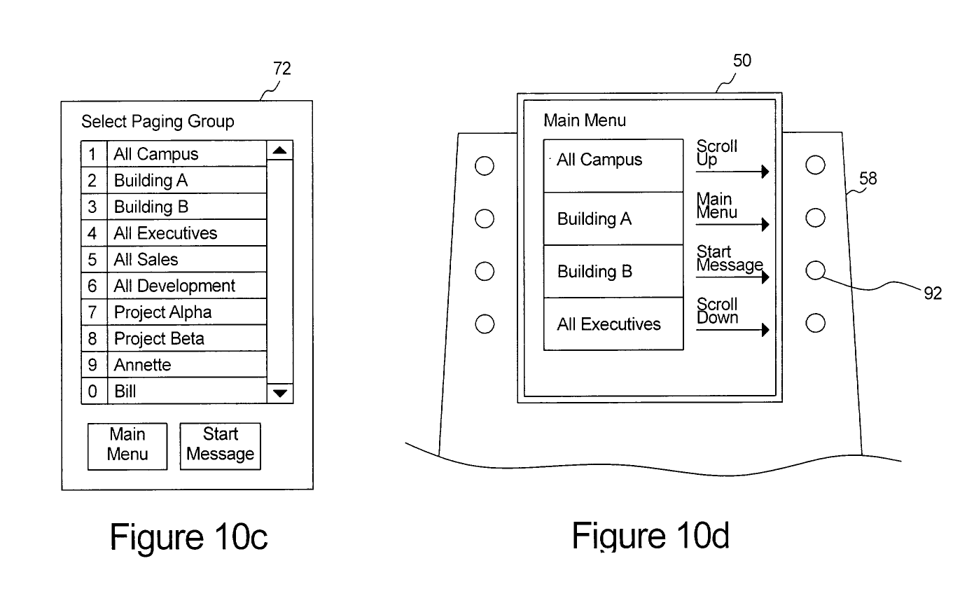

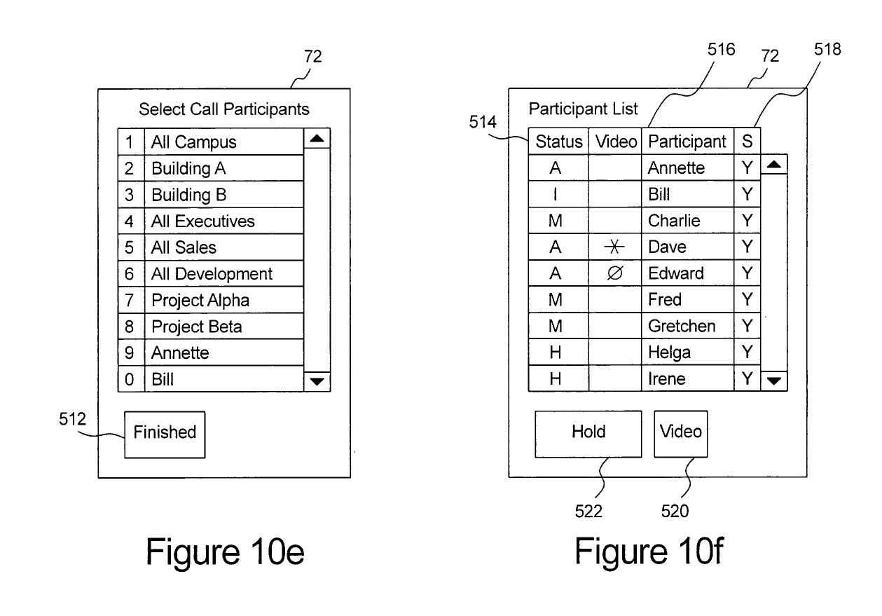

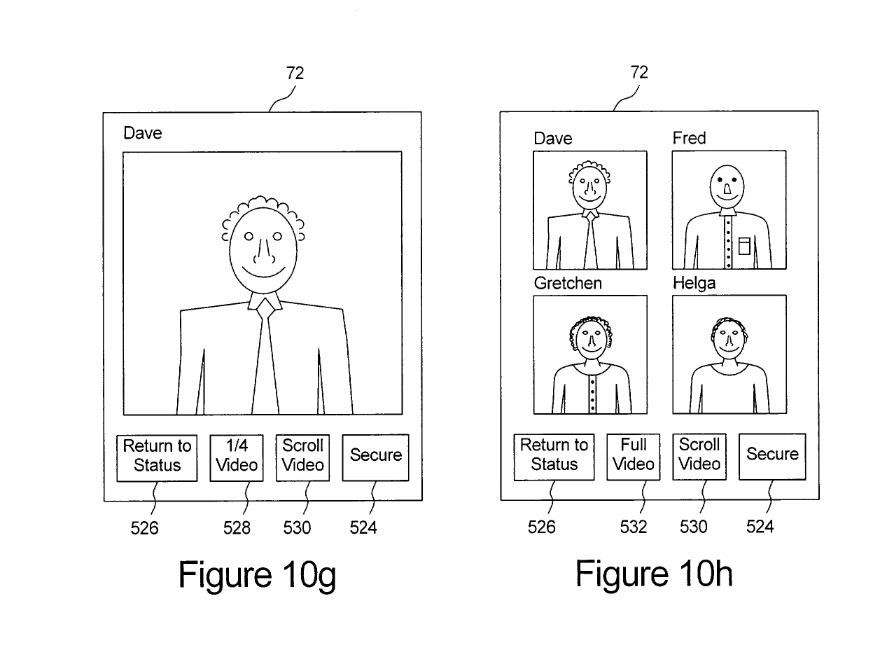

The video routing circuit receives a video stream from each participating endpoint that has video capture capabilities in the form of digital video data provided by the compression/encryption module 240. The video routing circuit also provides selected video streams back to each participating endpoint in accordance with instructions from the web server 230 discussed with respect to FIGS. 10e-10h.

The conference session control circuit receives conference set up signaling messages from an initiating subscriber station 24 that each includes a number identifying each conference participant. The conference session control circuit provides session signaling messages to the call signaling module, each including a number identifying a conference participant, such that the call signaling module may establish a communication session between the gateway 232 and each participant.

At any time during a conference session, the conference session control circuit may receive a message from a participating endpoint instructing the conference mix module 237 to secure the conference session. In response to such message, the conference session control circuit will instrict the call signaling module 227 to generate applicable messages to begin (or continue, or at least not stop) encrypting each VOIP session comprising the conference session and to report which, if any, VOIP sessions have successfully begun encryption (or continue to be encrypted).

After receiving a report of successful encryption, the control circuit will provide signals to the web server 230 so that the web server 230 may: a) update applicable displays associated with each participating subscriber station 24 as discussed with respect to FIGS. 10e-10h; and, b) if all VOIP sessions are secure, send a message to each participating subscriber station 24 to provide for the secure button 108 to illuminate.

Voice Mail Module

The voice mail module 236 includes circuits for providing a sequence of RTP frames representing applicable audio prompts from compressed audio prompt files 233 to the compression/encryption module 240, receiving RTP frames from the compression/encryption module 240 representing the voice of the remote caller leaving a message for the subscriber, compressing the message into a digital audio file, and sending the digital audio file to the email module 228 for storage in the email files 247 for later retrieval by the subscriber.

Email Module

The email module 228 maintains an email account associated with each subscriber. The email module 228 includes client circuits for interfacing with a remote email server. The email module 228 logs onto an account associated with each subscriber, obtains new email messages associated with the subscriber, and sends email messages drafted by the subscriber to the remote server. The email module 228 also maintains email files 247 in the storage 235 that may include an address book and an inbox for each subscriber.

WebServer

The web server application 230 provides additional multi media communication services provided to each subscriber. Examples of the multi media communication services provided to each subscriber by the web server application 230 include: a) delivery of email and voice mail messages (as emailed audio files) to the subscriber station 24 at which the subscriber's subscriber device 50 is then currently coupled; b) updating of the network location table 245 to assure proper routing of incoming audio and audio/video calls; c) proxy communication over network 18; d) delivery of multicast messages directed to a subscriber of the particular subscriber station 24 at which his or her subscriber device is then currently coupled; and e) providing subscriber control of audio and audio/video conference calls through the packet voice gateway 232.

The web server application 230 includes a multicast module 231 and an address translation module 31. The multicast module 231 provides IP multicast services to enable the web server application 230 to deliver select communications to multiple subscriber stations 24 simultaneously utilizing IP multicast protocols and without using excessive bandwidth on network 22. The address translation module 31 provides address and port translation services to enable the web server 230 to provide each subscriber station 24 with access to servers coupled to the network 18 as an IP layer proxy and without using higher layer resources of the control unit 12.

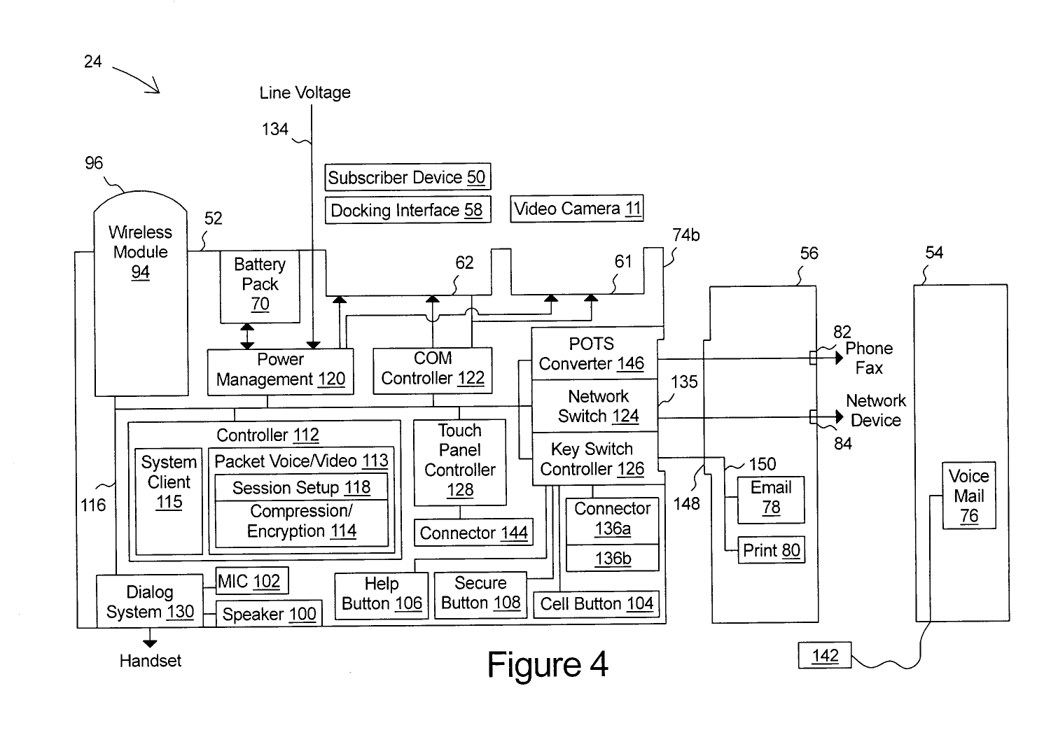

In the exemplary embodiment, non streaming media communication between the web server application 230 and each subscriber station 24 utilizes tagged data messages over a TCP/IP session between the web server application 230 and a system client application 115 (FIG. 4) within the subscriber station 24. Each message transferred between the web server application 230 and the subscriber station 24 comprises a data element and a tag identifying the significance of the data element. For example: a) if the data element comprises the text of an email message, the tag would identify the data element as the text of an e-mail message; b) if the data element comprises an executable script that would provide for the subscriber station 24 to perform a certain function, the tag would identify the data element as executable script and may identify the significance of the script; and c) if the data element comprises display layout control information (e.g. a style sheet) defining how another date element (such as the text of the email) should be displayed on a display screen, the tag would identify the data element as a style sheet.

Streaming media communications between the web server application 230 (such as multicast streaming media messages provided by the IP multicast module 231) and the client application 115 utilize a sequence of RTP frames that include compressed media data and are sent utilizing UDP/IP channels.

To provide communication services to each subscriber, the web server application 230 processes certain scripts in response to events generated by a subscriber station 24 and the packet audio/video gateway 232. In processing the scripts, the web server application 230 manages subscriber communication data stored in the storage 235 and provides operating instructions to subscriber station client 24 and the email module 228.

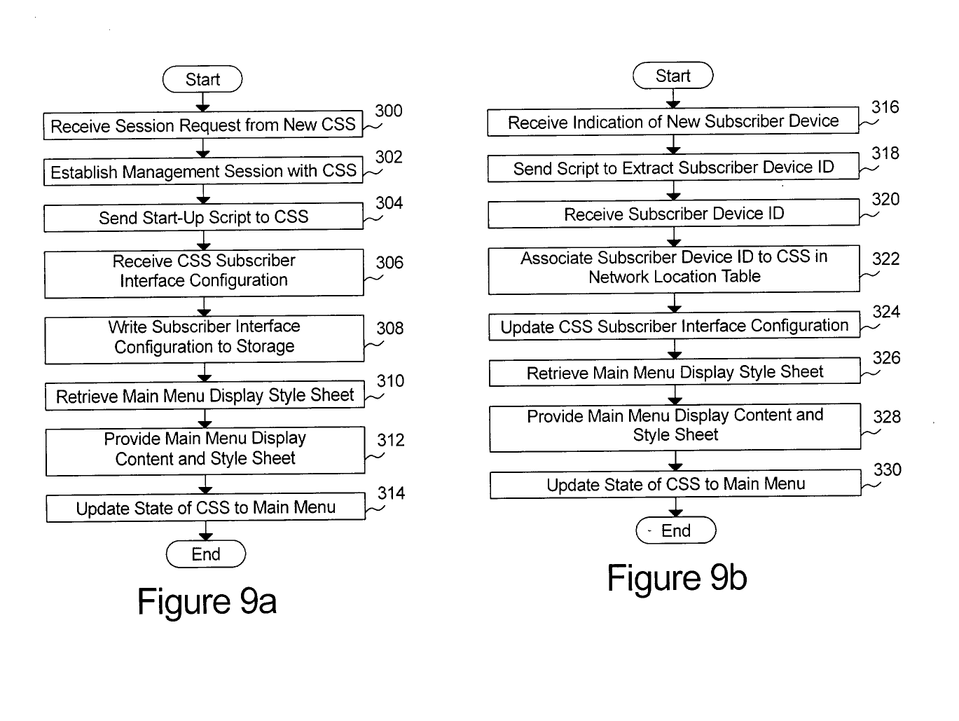

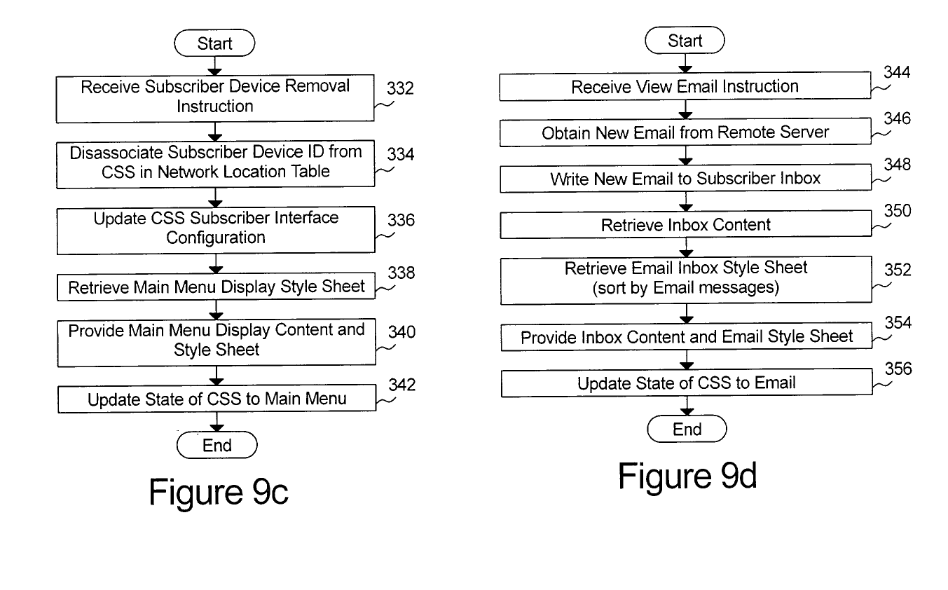

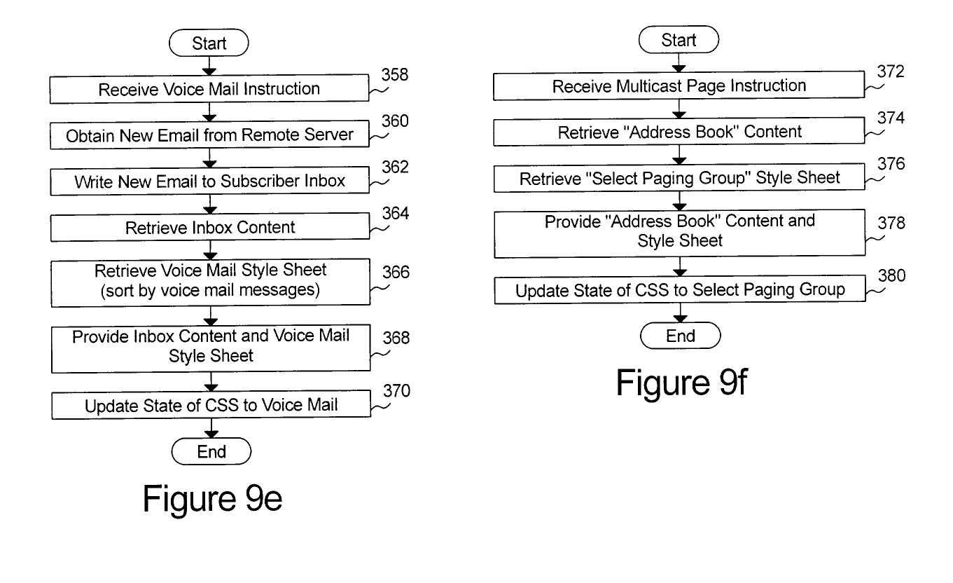

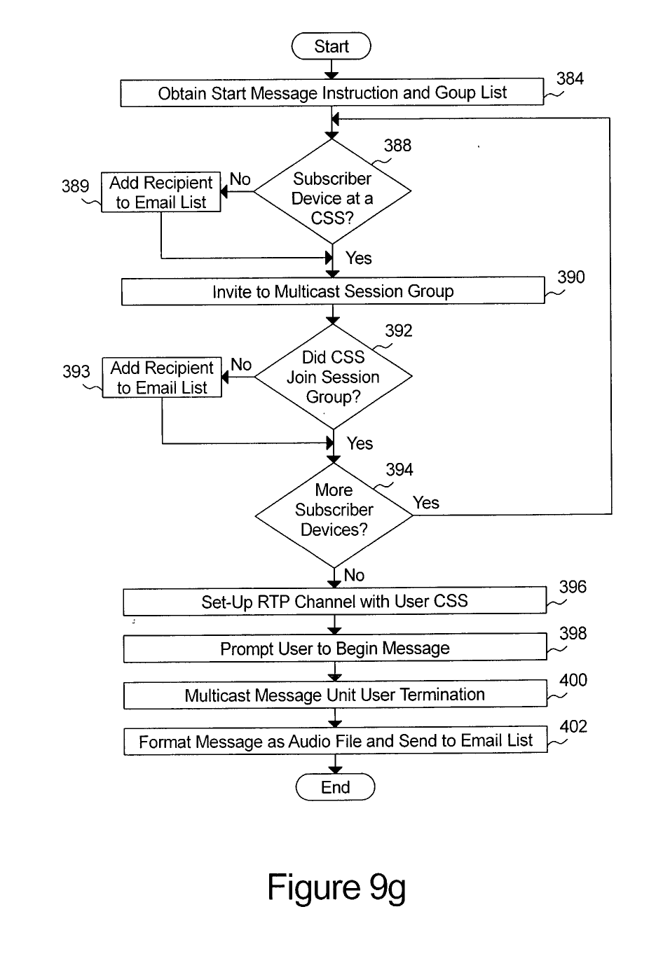

The flow charts of FIGS. 9a through 9g (which will be discussed in more detail herein) represent processing scripts that in aggregate provide for a subscriber to navigate through a layered menu to select applicable services form the control unit 12. The web server application 230 maintains state information for each subscriber station 24 such that each subscriber station 24 may navigate through the layered menu independently of other subscriber station units 24.

Subscriber Station

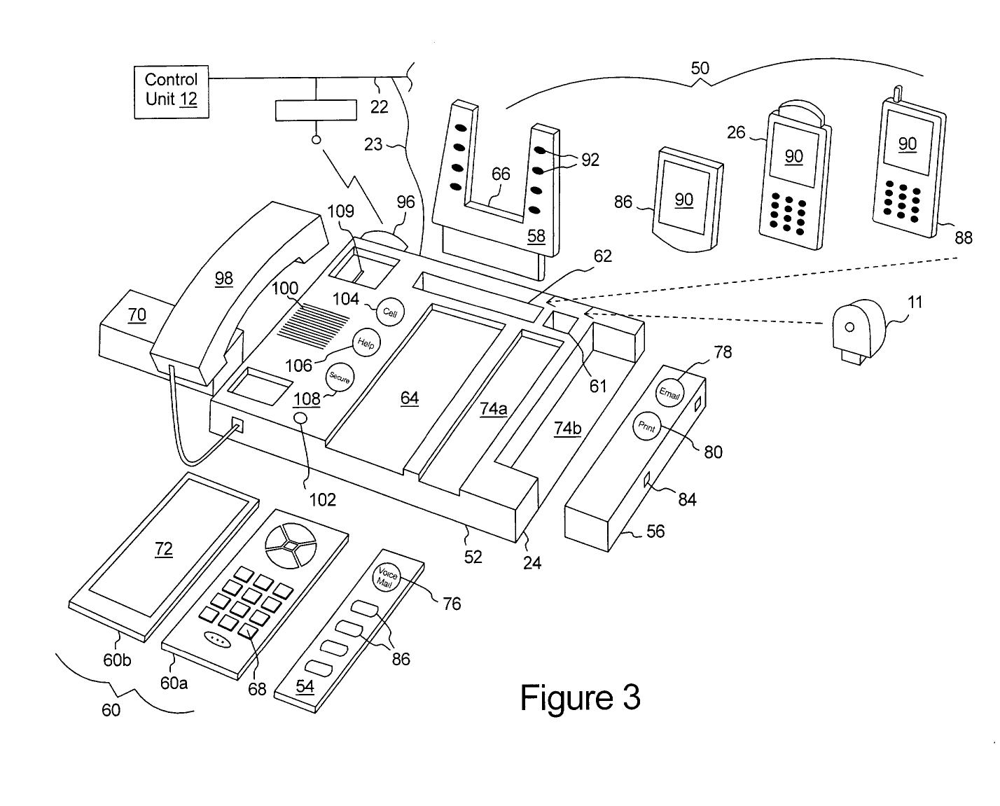

Referring to FIG. 3, a perspective view of an exemplary subscriber station 24 is shown. The subscriber station 24 includes a platform unit 52 that operatively couples to the control unit 12 via either a wireless communication link between a platform unit network circuit 96 and the wireless network 22 or a direct network connection 23 between the platform unit 52 and the backbone network of the wireless network 22.

A plurality of functional modules 54, 56, 58, 60, and 11 may be coupled to the platform unit 52 to form an integrated multi-media communication platform. The platform unit 52 includes a subscriber interface docking platform 64 for coupling and optionally supporting one of a plurality of modular subscriber interface units 60 to the platform unit 52. The modular subscriber interface unit 60a may include a plurality of buttons 68 in an arrangement similar to a typical telephone key pad to provide for subscriber input in a manner similar to that of a traditional telephone handset. The modular subscriber interface 60b may include a touch panel graphic display 72 to provide for subscriber input through virtual buttons visible thereon.

The platform unit 52 further includes a first function specific docking platform 74a and a second function specific docking platform 74b, each of which couples to respective function specific modules 54 and 56. The first function specific docking platform 74a is a shallow platform for coupling to function specific modules that primarily comprise function specific buttons or other circuits that may be placed within a thin module. The second function specific docking platform 74b is a larger platform for coupling to function specific modules with more complex internal circuits requiring the additional size.

In the exemplary embodiment, the function specific module 54 may include subscriber interface buttons configured for enhancing voice communication through the subscriber station 24 such as a voice message control 76 for single button access to voice message files and voice management controls 86 for single button control of enhanced voice management functions.

The function specific module 56 may include circuits configured for enhancing data communication through the subscriber station 24 such as an email control 78 for single button access to subscriber email messages, a print control 80 for single button initiation of the printing of an email message, and a data networking port 84.

The platform unit 52 further includes a docking bay 62 into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the platform unit 52. Exemplary configurations for the modular subscriber device 50 include a subscriber data assistant 86, a subscriber wide area network communication device 88, and the wireless LAN voice handset 26, each of which is discussed in more detail herein.

While operatively coupled to the platform unit 52, the subscriber device 50 becomes an integral part of the subscriber interface of the subscriber station 24. A liquid crystal graphic display 90 on the subscriber device 50 may function to display multi-media communication management information under control of the platform unit 52 and the control unit 12. Further, programmable subscriber controls 92 positioned adjacent to the subscriber device 50 may be configured to activate platform unit 52 and control unit 12 functions in accordance with the contents of the graphic display 90 adjacent to the controls 92.

The platform unit 52 also includes docking bay 61 into which a modular video camera 11 may be coupled to the subscriber station 24. The modular video camera 11 provides a video image for use by the subscriber station 24 when participating in a video conference call.

The platform unit 52 may further include one or more of the following elements: a) a handset 98 similar to a traditional telephone handset to provide a subscriber voice interface, b) a speaker 100 and a microphone 102 to provide a hands-free subscriber voice interface, c) a modular battery pack 70 (which fits within a battery pack bay that is not shown) for operating power when the subscriber station 24 is uncoupled from a line voltage, d) cell button 104 for single button selection of certain functions such as a wide area network communication function, e) help button 106 for single button selection of a help function, and f) a secure button 108, selection of which actuates encryption of the VOIP session supporting a subcriber's call from the subscriber station 24.

FIG. 4 shows a block diagram of the subscriber station 24. The platform unit 52 includes an application controller 112 coupled to a local bus 116 that interconnects the controller 112 with a plurality of peripheral circuits that include a wireless module 94, a power management controller 120, a communication controller 122, a network switch controller 124, a key switch controller 126, a touch panel controller 128, a plain old telephone service (POTS) converter 146, and a voice communication system 130.

The wireless module 94 operatively couples the platform unit 52 with the control unit 12 over the wireless LAN 22 (both of FIG. 1). The controller 112 includes appropriate drivers for operation of the wireless module 94.

The power management controller 120 selectively receives input power from the battery pack 70 or external line voltage 134. The power management controller 120 includes appropriate circuits for converting the input power voltage to appropriate operating power required by each component of the subscriber station 24. Additionally, the power management controller 120 includes appropriate circuits for managing charging of the battery pack 70 when the platform unit 52 is coupled to the line voltage 134 and generating appropriate power for operating and/or charging the modular docking interface 58 and the modular subscriber device 50 when coupled to the platform unit 52.

The communication controller 122 operatively couples the modular docking interface 58 and the modular subscriber device 50 to the controller 112 such that the platform 52 can exchange data with the modular subscriber device 50. In the exemplary embodiment, the communication controller 122 is a serial communication controller that enables the serial exchange of data with a compatible serial communication controller within the modular subscriber device 50 over a physical medium. Exemplary physical mediums include hardwired contacts, an infrared transmission, and RF transmission, however other physical mediums are envisioned and which medium is used is not critical to this invention.

The communication control 122 also operatively couples the modular video camera 11 to the controller 112 such that the platform unit 52 may power the video camera 11 and receive the video image from the video camera 11.

The network switch controller 124 provides a network data port 84 which enables the controller 112 to communicate with another network computing circuit over a network interface. The network switch controller 124 is coupled to a bus port 135 within the function specific docking platform 74b for coupling to a mating port 148 on the function specific module 56.

The key switch (e.g. button) controller 126 is coupled to: 1) a connector 136a which in turn is coupled to a mating connector on the modular subscriber interface unit 60a (FIG. 3) for interconnecting the buttons 68 to the key switch controller 126; 2) a connector 136b which in turn is coupled to a mating connector 142 on the function specific module 54 for interconnecting the buttons 76 and 86 to the key switch controller 126; 3) the bus port 135 which in turn is coupled to a mating port 148 on the function specific module 56 for interconnecting the buttons 78 and 80 to the key switch controller 126; 4) the cell button 104; 5) the help button 106; and 6) the secure button 108. In the exemplary embodiment, the key switch controller 126 may drive row and column signals to the various buttons and, upon detecting a short between a row and a column (e.g. button activation) reports the button activation to the application controller 112 over the bus 116. Again, the application controller 112 includes appropriate drivers for operating the key switch controller 126.

The touch panel controller 128 is coupled to a connector 144 which in turn is coupled to a mating connector on the modular subscriber interface unit 60b (FIG. 3) for interconnecting the touch panel graphic display 72 to the touch panel controller 128. In the exemplary embodiment, the touch panel controller 128 may include a separate display control circuit compatible with the resolution and color depth of the touch panel graphic display 72 and a separate touch panel control circuit for detecting subscriber contact with the touch panel graphic display 72. The application controller 112 includes appropriate systems for driving the contents of the touch panel graphic display 72 through the touch panel controller 128.

The voice communication system 130 generates analog voice signals for driving the speaker 100 (or the speaker in the handset 98 of FIG. 3) and detects input from the microphone 102 (or the microphone in the handset 98) under the control of the application controller 112.

The POTS converter circuit 146 provides a standard POTS port signal (e.g. tip and ring) for operation of a traditional telephone or a traditional fax machine coupled to a POTS port 82 on the function specific module 56. In operation the POTS converter 146 circuit interfaces between the POTS signal and the application controller 112.

In the exemplary embodiment, the controller 112 executes a packet audio/video communication client 113 and a client application 115. The packet audio/video communication client 113 includes a session set up circuit 118 and a compression/encryption circuit 114.

The session set up circuit 118 provides for sending (and responding to) applicable session signaling messages to (and from) another endpoint to establish a VOIP session with such other endpoint. The session set up circuit 118 also provides for sending (and responding to) applicable session signaling messages to (and from) the gateway 232 to initiate a conference session to conference session participants.

The compression/encryption circuit 114 exchanges the sequences of RTP frames representing compressed and audio data and video data, that may be encrypted, with the other endpoint and translates between compressed and optionally encrypted RTP frames and digital audio and digital video data, that may be encrypted. More specifically, the compression/encryption circuit 114 compresses video images from the video camera 11 into a sequence of RTP frames for sending to the other endpoint, compresses voice signals from the voice communication circuit 130 into sequences of RTP frames for sending to the other endpoint and decompresses RTP frames of video images and audio signals received from the other endpoint for driving the voice communication circuit 130 and for dispaying a video image on a display. In the exemplary embodiment, the packet audio/video communication client 113 may be one of the commercially available clients utilizing established protocols such as the International Telephone Union (ITU) H.323 protocols, The Internet Engineering Task Force (IETF) Session Initiation Protocols, or other protocols useful for signaling and establishing a real time streaming media session with the packet audio/video gateway 232.

The session set up module 118 includes circuits for generating and sending applicable messages to the other endpoint to initiate encryption of a VOIP session in response to operator activation of the secure button 108. The applicable messages will include negotiation of an encryption algorithm and the exchange of each endpoint's public encryption key. Further, in response to successful initiation of encryption during a VOIP session that is not a conference session, the session set up module 118 may generate an applicable signal to illuminate the secure button 108. Further, in response to an all-secure message from the conference module 237 during a conference session, the module may generate the applicable signal to illuminate the secure button 108.

The client application 115 operates as a client to the web server application 230 (FIG. 3) within the control unit 12. The client application 115 provides for the controller 112 to: a) generate an image on the touch panel graphic display 72 or on the graphic display 90 on the subscriber device 50 in accordance with display content and a style sheet received from the control unit 12; b) output an audio stream file received from the control unit 12 through the dialog system 130; c) execute processing steps in accordance with instructions received from the control unit 12; d) provide messages indicating subscriber actions (such as subscriber activation of the cell button 104, the help button 106, a touch panel virtual button, or any other button on the subscriber station 24) to the web server application 230; e) activate the packet audio/video client 113 to set up a real time audio/video session with the packet audio/video gateway 232 (FIG. 2); f) identify the modular configuration or subscriber interface configuration of the subscriber station 24 and report the configuration to the control unit 12; and g) report the coupling of (and decoupling of) a subscriber device 50 and/or modules to the platform 52 of the subscriber station 24 to the control unit 12.

Subscriber Data Assistant

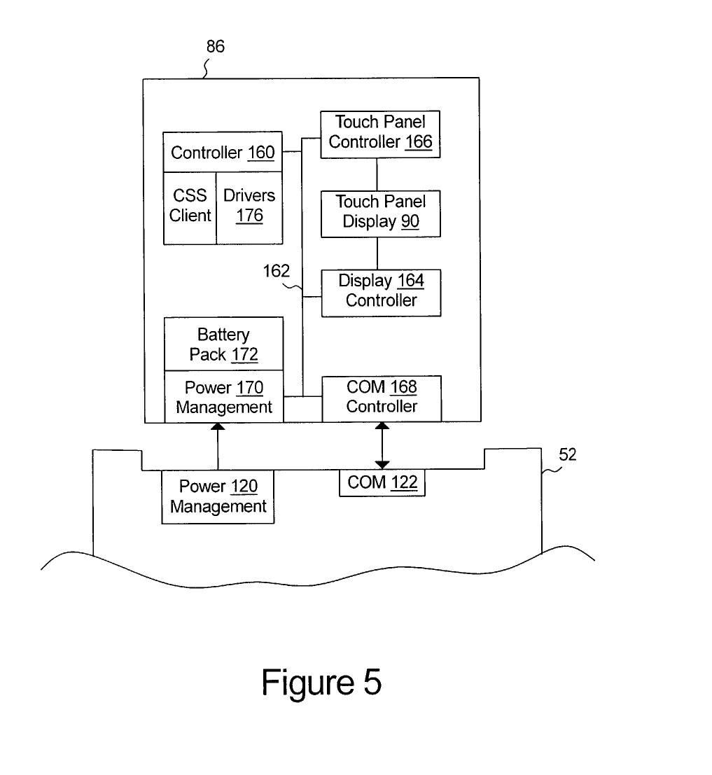

Turning to FIG. 5, exemplary structure of a subscriber data assistant 86 is shown. The subscriber data assistant 86 includes a controller 160 interconnected to a plurality of peripheral controllers by an internal bus 162. Because of the small size and the portability of the subscriber data assistant 86, the touch panel 90 provides the primary subscriber interface. The touch panel 90 is controlled by a display controller 164 and a touch panel controller 166. The display controller 164 drives the liquid crystal display of touch panel 90 using signals compatible with the resolution and color depth of the display 90. The touch panel controller 166 detects user activation of the touch panel 90. The controller 160 operates appropriate drivers 176 for controlling operation of the touch panel controller 166 and the display controller 164.

A communication controller 168 is also coupled to the bus 162 and operates under control of the application controller 160. In the exemplary embodiment, the communication controller 168 is a serial communication controller that is compatible with the communication controller 122 of the platform unit 52 (both of FIG. 4) such that data communication may occur between the platform unit 52 and the subscriber data assistant 86 when the subscriber data assistant 86 is operatively coupled to the platform unit 52.

A power management circuit 170 selectively receives input power from a battery pack 172 or from the power management circuit 120 in the platform unit 52. The power management circuit 170 includes appropriate circuits for converting the input power voltage to appropriate operating power required by each component of the subscriber data assistant 86. Additionally, the power management circuit 170 includes appropriate circuits for managing charging of the battery pack 172 when the subscriber data assistant is coupled to the platform unit 52.

The controller 160 also operates a subscriber station client application 174 for displaying multi-media communication management information under control the platform unit 52 when coupled to the platform unit 52. In the exemplary embodiment the subscriber station client application 174 receives messages from the platform unit 52 in the form of tagged messages. After receipt of the tagged messages, the subscriber station client application 174 builds a display document to display the communication management information represented by tagged content messages in accordance with a style sheet that is compatible with the size, resolution, and color depth of the touch panel display 90. The display document is then displayed on the touch panel display 90.

It should be appreciated that in additional to operating the drivers 176 and the subscriber station client application 174, the controller 160 may optionally operate any of the software applications that are commercially available for personal data assistants (PDAs) which may include address book management, calendar management, and games. While operation of such PDA applications may be useful to the subscriber, it is not critical to the operation of the present invention.

Subscriber Wide Area Network Communication Device

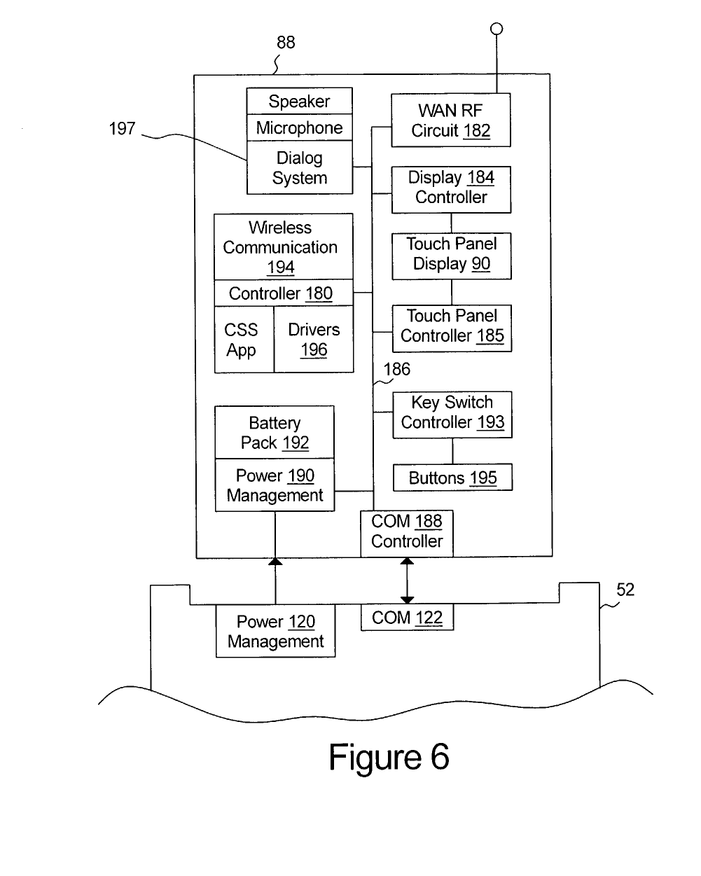

Turning to FIG. 6, exemplary structure of a subscriber wide area network communication device 88 is shown. The wide area network communication device 88 includes a controller 180 operating a Subscriber station application 174′, the subscriber contact directory application 178, a wireless communication application 194, and applicable drivers 196 for a plurality of peripheral controllers. The controller 180 is interconnected to the plurality of peripheral controllers by an internal bus 186. The peripheral controllers include a wide area network RF circuit 182, a voice system 197, a display controller 184, a touch panel controller 185, a key switch controller 193, a communication controller 188, and a power management system 190.

The wide area network RF circuit 182 may be a circuit for transmitting and receiving signals from a wide area network service provider's medium under control of the wireless communication application 194. Exemplary wide area network service provider mediums include an analog or digital cellular or PCS telephone RF system.

The key switch controller 193 is coupled to the control buttons 195. The key switch controller 193 drives row and column signals to the control buttons 195 and, upon detecting a short between a row and a column indicating button activation, reports the activation to the controller 180. The control buttons may be used by a subscriber for operating the wide area network communication device 88 when uncoupled form the platform unit 52.

The voice system 197 includes a speaker and a microphone. Under control of the wireless communication application 194, the voice system 197 may provide a subscriber voice interface for an audio session with a remote device over the wide area network service provider's medium.

The display controller 184 drives the display 90 using signals compatible with the resolution and color depth of the display 90. The display 90 may optionally be a touch panel display 90 and the touch panel controller 185 detects user activation of the touch panel 90.

The communication controller 188 may be a serial communication controller compatible with the communication controller 122 in the platform unit 52 such that data communication may occur between the platform unit 52 and the wide area network communication device 88 when the wide area network communication device 88 is operatively coupled to the platform unit 52.

The power management controller 190 operates with a battery pack 192, both of which may operate in a similar manner to the power management controller 170, and the battery pack 172 discussed with reference to FIG. 5.

Similar to the subscriber data assistant 86 (FIG. 5), when the wide area network communication device 88 is coupled to the platform unit 52, the Subscriber station application 174′ provides for displaying multi-media communication management information under control of the platform unit 52 and provides for multi-media communication directly between the platform unit 52 and the wide area network service provider medium.

In addition the Subscriber station application 174′ may receive messages from the platform unit 52 which may be multi-media communication messages for communication over the wide area network service provider medium. Each message includes a tag that identifies the contents of the message. After receipt of a tagged message, the Subscriber station application 174′ may identify whether the message is for communication with the wide area network service provider medium or whether it is multi-media communication management information for display.

When the message is for communication with the wide area network service provider medium, the Subscriber station application 174′ will reformat the message to a format compatible with wide area network service provider medium transmission standards and transmit the message using the wide area network RF circuit 182.

The wide area network communication device 88 may also receive signals from the wide area network service provider medium via the wide area network RF circuit 182. When received, the Subscriber station application 174′ reformats the messages into a plurality of tagged messages for communication to the platform unit 52 and sends the tagged messages to the platform unit 52 via the communication controller 188.

Wireless Voice Handsets

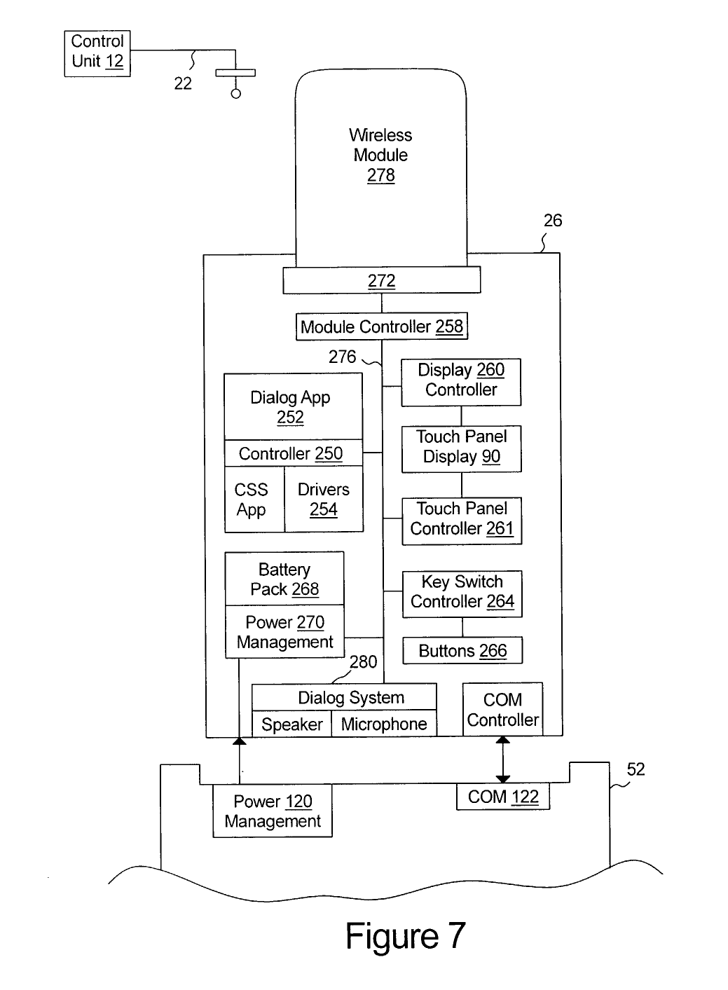

FIG. 7 shows a block diagram of an exemplary wireless dialog handset 26. The wireless voice handset 26 includes a network circuit 278 and a controller 250 that operates a Subscriber station application 174″, the subscriber contact directory application 178, a LAN communication application 252, and applicable drivers 254 for each of a plurality of peripheral controllers. The controller 250 is interconnected by a bus 276 to the plurality of peripheral controllers which include a module controller 258, a display driver 260, a touch panel driver 261, a key switch controller 264, and a power management circuit 270.

The module controller 258 operatively couples the network circuit 278 to the controller 250 such that the wireless voice handset 26 may communicate with the control unit 12 over the wireless LAN 22 (both of FIG. 1). In the exemplary embodiment, the module controller 258 may be a PCMCIA controller circuit and the network circuit 278 is configured as a PCMCIA card that couples to the module controller 258 through a PCMCIA connector 272. The LAN communication application 252 operates the network circuit 278 for communicating with the control unit 12 using appropriate wireless signaling protocols.

The key switch controller 264 1s coupled to the control buttons 266. The key switch controller 264 drives row and column signals to the control buttons 266 and, upon detecting a short between a row and a column indicating button activation, reports the activation to the controller 250. The control buttons may be used by a subscriber for operating the wireless voice handset 26 when uncoupled form the platform unit 52.

The display controller 260 drives the display 90 (optionally a touch panel display 90) using signals compatible with the resolution and color depth of the display 90. The touch panel controller 261 detects user activation of the touch panel display 90. The power management controller 270 operates in conjunction with a battery pack 268, both of which may operate in a similar manner to the power management controller 170, and the battery pack 172 discussed with reference to FIG. 5.

When the wireless voice handset 26 is coupled to the platform unit 52, the Subscriber station application 174″ provides for displaying multi-media communication management information under control the platform unit 52. Additionally, the Subscriber station application 174″ may receive multi-media communication management information content messages and control messages directly from the control unit 12 via the wireless network 22. After receipt of the tagged messages from either the platform unit 52 or the control unit 12, the Subscriber station application 174″ builds a document to display the communication management information represented by the tagged content messages in accordance with display layout control messages that are compatible with the size, resolution, and color depth of the touch panel display 90. The display document is then displayed on the touch panel display 90.

Conferencing A Wireless Caller

In addition to the aforementioned conference call capabilities the system 10, of the present invention can also be modified to permit wireless callers to conference into an existing conference call. As described more fully below, when a subscriber is participating in a conference call and the subscriber receives a call on a wireless telephone (e,g. the wireless call devices described above with reference to FIGS. 6 and 7), the subscriber can place the wireless phone into the subscriber station docking bay, press the cell button and the wireless caller is joined into the conference call. Alternatively, if the subscriber is participating in a wireless call, the subscriber may place the wireless phone into the docking bay, initiate a conference call to other participants (in a manner described above) and join the wireless caller into the conference call.

To provide this functionality, the subscriber station 24 depicted in FIGS. 3 and 4 is adapted to communicate with the wireless telephone devices depicted in FIGS. 6 and 7, as follows. The controller 112 (FIG. 4) may be adapted to include wireless telephone support circuitry that interfaces with the subscriber station application 198 of the wireless communication device of FIG. 6 and/or 256 (FIG. 7), and with the packet voice/video circuitry 113 in the subscriber station. Communication with the devices of FIG. 6 and 7 may be accomplished through the COM controller 122 via the docking station 62 and docking interface 58, as described above or using some other conventional and/or proprietary communication protocol as maybe known in the art.

Controller 112 (implemented with wireless telephone support circuitry) exchanges commands and data with the wireless communication device of FIGS. 6 and/or 7, in a manner that is described above. For conference call capabilities with a wireless caller, the packet voice/video circuitry 113 communicates with the wireless telephone support circuitry to initiate a second VOIP session to the packet voice gateway 232 (FIG. 2) to conference in a wireless call into a conference call. Thus, the subscriber participating in a conference call from the subscriber station 24 and the remote person participating through a wireless telephone docked in the subscriber station are on two separate VOIP sessions to the gateway 232. In this manner, each device can receive its own mix signal from the gateway 232. After the second VOIP session is initiated, it is maintained and the packet voice/video circuitry 113 relays data representing audio to the wireless telephone.

Accordingly, the packet voice gateway 232 of the control unit 12 is adapted to initiate multiple VIOP sessions, one for each end point beyond two. Multiple VIOP sessions is described above in detail. Thus, the present invention provides seemless integration for conferencing in wireless communication devices into a conference call.

During the course of a wireless call when the subscriber station is also participating in a VOIP session with the gateway 232, the wireless telephone support circuitry relays data representing audio between the application 198/256 and the packet voice/video circuit 113 so that data representing audio can be encapsulated into RTP frames and sent over the second VOIP session to the gateway 232.

Referring briefly again to FIG. 2, the conference mix circuit 232 adds an additional participant in response to a participating subscriber station establishing a second VOIP session to the gateway 232. Mix circuit 232 also can provide messages to conference in the new VOIP session. Of course, the encryption circuitry 240 described above may be similarly used for conference calling with a wireless participant.

Additionally, the subscriber station 24 may be adapted to send ring signals to the wireless telephone support circuitry to signal an incoming wireless call (if, for example, the wireless telephone is situated in the docking station), receive an off-hook signal from the wireless device, answer the wireless call, and/or relay data representing the audio to the wireless telephone support circuitry so that a subscriber can participate in a wireless call through the subscriber station dialog system 130. For example, during the course of a wireless call (not a conference call but rather a wireless call answered through the subscriber station) the wireless telephone support circuitry exchanges data representing audio with the application 198/256 so that audio can be input and output through the dialog system 130.

The wireless telephone support circuitry may be adapted to receive ring signals from the application 198/256 and generate audio ring signals through the speaker 100 provided with the subscriber station, and likewise adapted to send signals to the application 198/256 to answer a ringing wireless telephone (for example, by activation of the cell botton on the subscriber station). During the course of a wireless call that is answered through the subscriber station, the wireless telephone support circuitry may also be adapted exchange data representing audio with the application 174/256 so that the audio can be input and output through the dialog system 130, in a manner described above.

It should be understood that although the specific example of conference call capabilities is described herein with reference to audio, as described above the present invention is equally adapted to include video conference support. Further, although the exemplary embodiment described above references VIOP sessions, the present invention could likewise use switched circuit audio sessions, instead of VIOP, thereby providing conference call capabilities to a wide range of wireless devices.

Although the wireless telephone support circuitry is not specifically depicted in the Figures, it will be readily understood that such circuitry may be represented in the controller 112 (FIG. 4). It will be further understood that such circuitry may comprise logical instructions embodying the following description of conference call capabilities (which may comprise a mixture of hardware and/or software and/or firmware programmed to execute logical instructions in such a manner), and/or other circuitry that may be known in the art.

Web Server Application

Referring to FIGS. 9a through 9j in conjunction with FIG. 2, exemplary processing steps performed by the web server application 230 to provide communication services to a subscriber station 24 are shown.

The flowchart of FIG. 9a represents steps performed by the web server application 230 upon receiving an open session request on a predetermined port from a subscriber station 24 that has just been operatively coupled to the network 22, obtained a network address from the network address server 220, and is ready to operate as a client to the web server application 230. Step 300 represents receipt of the open session request and step 302 represents establishing a TCP/IP session with the subscriber station 24.

Step 304 represents sending a start up script to the subscriber station 24. The start up script includes instructions that, when executed by the client application 115, provide for the subscriber station 24 to detect its subscriber interface configuration (e.g. whether the subscriber station 24 includes a display screen and what capabilities such as video capabilities and graphic resolution capabilities the display screen may have) and to report its subscriber interface configuration back to the web server application 230.

Step 306 represents receipt of the subscriber interface configuration of the subscriber station 24 from the subscriber station 24 and step 308 represents writing an indication of the subscriber interface configuration of the subscriber station 24 to a subscriber interface table 239 in the storage 235.

Step 310 represents retrieving a main menu display style sheet from a selection of style sheets 241 stored in the storage 235. The retrieved main menu display style sheet will be a style sheet that corresponds to the subscriber interface configuration of the subscriber station 24.

Step 312 represents providing main menu display content and the style sheet to the subscriber station 24 and step 314 represents updating a subscriber station state table 243 in the storage 235 to indicate that the subscriber station 24 is in a main menu state.

It should be appreciated that the main menu content provided to the subscriber station 24 is independent of the subscriber interface, however, the style sheet provided to the subscriber station 24 is dependent on the subscriber interface. For example, turning to FIG. 10a which represents display of a main menu on a subscriber device 50 in the modular docking interface 58 the content of the main menu display includes a title of main menu and choices of view email, voice mail, and multi cast paging. The style sheet corresponding to a subscriber interface that includes a subscriber device 50 provides for the content to be graphically displayed with the title at the top and each menu choice to be displayed adjacent a button 92 on the modular docking interface 58. Alternatively, turning to FIG. 10b which represents display of a main menu on a display 72 that is coupled to a subscriber station interface 64 (FIG. 3), the content of the main menu display again includes a title of main menu and the choices of view email, voice mail, and multi cast paging. However, the style sheet that corresponds to a subscriber interface that includes a display 72 that is coupled to a subscriber station interface 64 provides for the content to be graphically displayed with the title at the top and each choice to be displayed in a vertical list with an adjacent numeral for selection using the keypad 68 (FIG. 3). The examples shown FIGS. 10a and 10b are for illustrative purposes only. Other subscriber interface configurations that include non-graphic displays, bit mapped multi line text displays, or 7 element single or multi line text displays may utilize different style sheets for displaying all or a portion of the main menu content.

The flowchart of FIG. 9b represents steps performed by the web server application 230 upon receiving an indication that a subscriber device 50 has been coupled to a subscriber station 24. Step 316 represents receipt of such indication.

Step 318 represents sending a device ID extraction script to the subscriber station 24. The device ID extraction script includes instructions that, when executed by the client application 115, provide for the subscriber station 24 to interrogate the subscriber device 50 to determine its device identification (e g an identification of which subscriber to which the device has been assigned) and to report the device identification back to the web server application 230.

Step 320 represents receipt of the device identification back from the subscriber station 24 and step 322 represents associating the device ID with the subscriber station 24 in the network location table 245 in the storage 235. As discussed previously, the packet audio/video gateway 232 utilizes the network location table 245 for routing incoming telephone calls to the particular subscriber station 24 at which a subscriber's subscriber device 50 is then currently coupled. It should be appreciated that this step 322 provides for the network location table 245 to properly indicate association between a subscriber station 24 and the subscriber device 50 that is served thereby.

Because the style sheet selected for display of content on the subscriber station 24 is dependent on the subscriber interface configuration of the subscriber station 24 as determined by the subscriber interface table 239, the table should be updated when the subscriber interface configuration changes. Coupling a subscriber device 50 to a subscriber station 24 changes the subscriber interface because the display of the subscriber device 50 becomes a display for the subscriber station 24. As such, step 324 represents updating the subscriber interface configuration of the subscriber station 24 in the subscriber interface table 239.

Step 326 represents retrieving a main menu display style sheet that is applicable to the new subscriber interface configuration from the selection of style sheets 241 in the storage 235 and step 328 represents providing main menu display contend and the style sheet to the subscriber station 24. Step 330 represents updating the subscriber station state table 243 to assure that it represents that the subscriber station 24 is in the main menu state.

The flow chart of FIG. 9c represents steps performed by the web server application 230 upon receiving an indication that a subscriber device 50 has been removed from a subscriber station 24. Step 322 represents receipt of such an indication.

Because the packet audio/video gateway 232 utilizes the network location table 245 for routing incoming telephone calls to the particular subscriber station 24 at which a subscriber's subscriber device 50 is then currently coupled, the network location table should be updated upon removal of a subscriber device form a subscriber station 24. Step 334 represents disassociating the subscriber device 50 from the subscriber station 24 in the network location table 245.

Because the display on the subscriber device 50 is no longer part of the subscriber interface of the subscriber station 24 after the subscriber device 50 is removed, step 336 represents updating the subscriber interface configuration table 239.

Step 338 represents retrieving a main menu display style sheet that is applicable to the subscriber interface configuration without the subscriber device 50 from the selection of style sheets 241 in the storage 235 and step 340 represents providing main menu display content and the style sheet to the subscriber station 24. Step 342 represents updating the subscriber station state table 243 to assure that it represents that the subscriber station 24 is in the main menu state.

The flowchart of FIG. 9d represents steps performed by the web server application 230 upon receiving a subscriber indication of a command to view subscriber email messages. The means by which the subscriber station 24 may detect such a subscriber indication is dependent on the subscriber interface configuration of the subscriber station 24. For example, if the subscriber interface includes the email button 78 (FIG. 3), detection of button 78 activation would be a subscriber indication of a command to view subscriber email messages. Similarly, subscriber activation of the email menu choice on the main menu either by touch panel activation or by activation of a button associated with the menu choice (either or both of which may be applicable dependent on the subscriber interface configuration) would be a subscriber indication of a command to view subscriber email messages. Step 344 represents the web server application 230 receiving the subscriber indication of a command to view subscriber email messages.

Step 346 represents instructing the email module 228 to logon to an email server (which may be a remote email server coupled to the network 18) and to receive new email messages associated with the subscriber's account. Step 348 represents writing the new email messages to the subscriber inbox in the email files 247 in the storage 235. In an embodiment wherein the remote email server maintains subscriber inbox information, steps 346 and 348 may be viewed as synchronizing the email messages between the remote server and the email files 247. It should also be appreciated that the email module 228 may periodically retrieve new email messages and write to the subscriber inbox independently of whether the subscriber has activated an email control. As such, the inbox will already include new messages and steps 346 and 348 may not need to be preformed in response to event 344.

Step 350 represents retrieving inbox content from the email files 247 and step 352 represents retrieving an inbox style sheet that is applicable to the subscriber interface from the style sheets 241 in the storage 235. Because the subscriber's voice mails will be sent to the subscriber's email account as audio files, it is possible that the email messages retrieved at step 346 will include both text based emails and emails from the voice mail server 236. Because the subscriber activated a command to view email messages, the inbox style sheet provides for the display of the email messages received from senders other than the voice mail server 236 to be displayed first (or on the top of the display).

Step 354 represents providing the inbox content and style sheet to the subscriber station 24 and step 356 represents updating the subscriber station state table 243 to indicate that the subscriber station 24 is in an email state.

The flowchart of FIG. 9e represents steps performed by the web server application 230 receiving a subscriber indication of a command to obtain voice mail messages. Again, the means by which the subscriber station 24 may detect such a subscriber indication is dependent on the subscriber interface configuration of the subscriber station 24. For example, if the subscriber interface includes the voice mail button 76 (FIG. 3), detection of button 76 activation would be a subscriber indication of a command to obtain voice mail messages. Similarly, subscriber activation of the voice mail menu choice either by touch panel activation or by activation of a button associated with the menu choice would be a subscriber indication of a command to obtain voice mail messages. Step 358 represents the web server application 230 receiving the subscriber indication of a command obtain voice mail messages.

Because voice mail messages will be sent as audio files form the voice mail server 236 to the subscriber's email account, step 360 represents instructing the email module 228 to logon to the email server and to receive new email messages associated with the subscribers account. Step 362 represents writing the new email messages to the subscriber inbox in the email files 247 in the storage 235.

Step 364 represents retrieving inbox content from the email files 247 and step 366 represents retrieving an voice mail style sheet that is applicable to the subscriber interface from the style sheets 241 in the storage 235. Because the email messages that include voice mail audio Flies from the voice mail server 236 may be intermixed with email messages from other senders, the voice mail style sheet provides for only the display of the voice mail messages received from the voice mail server 236.

Step 368 represents providing the inbox content and the voice mail style sheet to the subscriber station 24 and step 370 represents updating the subscriber station state table 243 to indicate that the subscriber station 24 is in a voice mail state.

The flowchart of FIG. 9f represents steps performed by the web server application 230 upon receiving a subscriber indication of a command to initiate a multicast paging message. The subscriber station 24 may detect such a subscriber indication by various means, such as touch panel activation of button activation of a menu selection on the main menu, dependent on the subscriber interface configuration of the subscriber station 24. Step 372 represents the web server application 230 receiving the subscriber indication of a command to initiate a multicast paging message.

Step 374 represents retrieving the subscriber's address book content 249 from the email files 247. Turning briefly to FIG. 8b, the address book content 249 may comprise a plurality of records with each record including a group identification name and identification of each subscriber in such group, and, if the group identifies a single person, contact information for the person.

Step 376 represents retrieving a select paging group style sheet that corresponds to the subscriber interface of the subscriber station 24 and step 378 represents providing both the address book content and the select paging group style sheet to the subscriber station 24. Step 380 represents updating the subscriber station state table 243 to indicate that the subscriber station 24 is in the select paging group state.

FIG. 10c represents an exemplary display of the select paging group content utilizing a style sheet that may be applicable for use on a display 72 wherein the subscriber may use buttons or touch panel activation may be utilized to select one or more paging groups to include in the multicast page. It should be appreciated that some paging groups may include only a single name such that individuals may be selected to include in the multicast page. Because the list of groups included in the paging group content may be larger than can be displayed on the display 72, the style sheet may provide for only a portion of the content to be displayed along with touch activated scroll controls for display of the remainder of the content. The style sheet may further include touch activated controls to return to the main menu and to start the multicast message.

FIG. 10d represents an exemplary display of the select paging group content utilizing a style sheet that may be applicable for display of the content on a display of a subscriber device 50 coupled in the modular docking interface 58. Because subscriber selection is to be by activation of buttons 92, the style sheet provides for the content to be displayed with the groups on the left side for selection by buttons 92 on the left side of the modular docking interface 58 and for indicators to label the function of the buttons 92 on the right side of the modular docking interface 58 such as scroll up, scroll down, start message, and return to main menu.

The flowchart of FIG. 9g represents steps performed by the web server application 230 upon receiving a subscriber indication of a command to start the multicast paging message. Step 384 represents receipt of such a subscriber indication along with identification of the subscriber selected multicast groups to include in a multicast recipient list.

Steps 388 through 394 represent steps that are performed by the web server application 230 for each recipient. Such steps may be performed in sequence or in parallel. For purposes of illustration, the steps are shown performed in sequence. Step 388 represents identifying the subscriber device 50 that is associated with the recipient and determining if the subscriber device is then currently coupled to a subscriber station 24. If yes, step 390 represents inviting such subscriber station 24 to the multicast session group. However, if the subscriber device 50 associated with the recipient is not coupled to a subscriber station 24 where the subscriber may receive the multicast, then at step 389 the recipient is added to an email list.

Following step 390, step 392 represents determining whether the subscriber station 24 joined the multicast session group. If the subscriber station 24 is operating a voice session, it would be inappropriate to interrupt the voice session with a multicast page for the subscriber. As such, it is envisioned that the subscriber station 24 may, when in certain operational states, not join the multicast session group. In which case, the recipient is added to the email list at step 393. At this time, the voice mail module 236 is invited to the multicast session group to receive the multicast on behalf of each recipient added to the email list at step 389 or 393.

After the recipient is either added to the email list at step 393 or the subscriber station 24 joined the multicast session group at step 392, step 394 represents determining if steps 388 though 392 must be performed for additional recipients. If not, step 396 represents establishing a RTP channel with the subscriber station 24 that initiated the multicast paging message and step 398 represents instructing the web server 230 to prompt the subscriber to begin the multicast paging message.

Step 400 represents multicasting the message to the session group utilizing the multicast module 231 and step 402 represents instructing the voice mail module 236 to terminate the multicast, build an audio file, and send the audio file by email to each recipient that was added to the email list at either step 389 or 393.

The flowchart of FIG. 9h represents steps performed by the web server 230 upon receiving a subscriber indication of a command to initiate an audio or an audio/video conference call from a subscriber station 24. The subscriber station 24 may detect such a subscriber indication by various means, such as by subscriber activation of the conference call control 502 on the touch panel 72 of FIG. 10b or by activation of a button 92 corresponding to the conference call menu selection on the display screen 50 of FIG. 10a. Step 404 represents the web server 230 receiving such an indication from a subscriber station 24.

Step 406 represents retrieving the subscriber's address book content 249 from the email files 247 and step 408 represents retrieving a “select conference session participants” that corresponds to the subscriber interface of the subscriber station 24 from the style sheets 241 in the storage 235. Step 410 represents providing both the address book content and the style sheet to the subscriber station 24 for display.

Step 412 represents receiving subscriber selection of participants for the conference call. FIG. 10e represents an exemplary display of the address book for selection of conference call participants on the touch panel 72. The subscriber station 24 may detect subscriber activation of the touch panel 72 to “highlight” conference call participants and indicate that selection is complete by activating a finished control 512. Upon activation of the finish control 512, the subscriber station 24 will provide the subscriber selection of participants to the web server 230.

Step 414 represents instructing the session set up module 118 to initiate a conference call by providing the session participant list to the packet audio/video gateway 232 as discussed above and step 416 represents updating the state of the subscriber station 24 to a conference call state.

After receiving the session participant list from the web server 230, the packet audio/video gateway 232, or more specifically the call signaling module 227 (FIG. 2) will establish applicable audio and video communication channels with those subscriber stations 24 that are serving subscriber devices associated with the participants in accordance with the steps discussed with respect to FIG. 11a. With the communication channels open, the packet voice gateway 232 will activate the conference mix module 237 to begin mixing the audio streams from each subscriber station 24 participating in the conference call and will report the status of each participant to the web server 230 as discussed above. More specifically, the status will include an indication of whether each session participant is connected to the conference or is inactive (not connected to the conference) and will include an indication of whether each session participant is on a secure VOIP session with the packet voice gateway 232. As will be discussed later, the status may also indicate whether the participant has stopped providing an active audio stream (e.g. put his or her phone on mute) and may indicate whether the conference mixing module 237 has suspended sending a conference mix to the participant (e.g. the packet audio/video gateway 232 has placed a particular participant on hold for a time period to so that others can converse without such participant hearing the conversation).

The flowchart of FIG. 9i represents steps performed by the web server application 230 upon receiving conference status content from the packet audio/video gateway 232. Step 418 represents receipt of the status content. Step 419 represents retrieving a “status” style sheet form the style sheets 241 in the storage 235 and step 420 represents providing the status content and the style sheet to at least the initiating subscriber station 24 and optionally, to other subscriber stations 24 participating in the conference call. It should be appreciated that the steps for the flowchart of FIG. 9i may be repeated several times during the duration of a conference call as the status of each participant changes.

FIG. 10f represents an exemplary display of the status of each participant on the touch panel 72. The display includes a vertical listing of each participant and an indication of the participants status in a column 514. An “A” indicates that the participant is active (e.g. sending a non-mute audio stream and receiving a conference mix audio stream). An “I” indicates that the participant is not on the conference call. A “M” indicates that the participant has muted his or her telephone and is not sending an audio stream. An “H” indicates that the participant has been placed on hold by the initiating subscriber station and is not receiving a conference mix.

The display also includes a video indication column 516. This column indicates which participants are not sending a video image signal to the packet voice/video gateway 232 (e.g. the “Φ” symbol). Because the subscriber may select which of the participants to view during a video conference, the video column 516 will also indicate the subscribers selection of the video image to view if the subscriber activates the video control 520. In the exemplary display, the “*” symbol associated with Dave indicates that the subscriber would view the video image provided by Dave's subscriber station 24 upon activating the video control 520. The subscriber may change such selection by utilizing the controls of the touch panel 72. Upon detecting activation of the video control, the communicating subscriber station 24 will report the indication to the web server application 230.

The display also includes a hold control 522. The initiating subscriber may indicate his or her desire to place a participant(s) on hold status by highlighting the participant(s) and activating the hold control 522. Upon detecting activation of the hold control 522, the subscriber station 24 will report the indication to the web server application 230. Upon receiving the indication, the web server application 230 will provide the indication to the packet voice/video gateway 232 which will place the selected participant(s) on hold status and return updated status content to the web server application 230.

The display further includes a secure/encryption indication column 518. Symbols in the column 518 indicate whether communications between the associated participant are over a secure VOIP session. A “Y” indicates that such communications are secure while a “N” indicates that communications with the associated participant are not secure.

The flow chart of FIG. 9j represents steps performed by the web server 230 upon receiving a subscriber indication of a video image selection from a subscriber station 24. Step 426 represents such receipt by the web server 230. Step 428 represents providing the video image selection to the packet voice/video gateway 232. The packet voice/video gateway 232 will then begin relaying the selected video image to the subscriber station. Step 430 represents the web server application 230 retrieving a style sheet for the display of the video image. Step 432 represents providing the style sheet to the subscriber station 24 and step 434 represents providing instructions to display the video image received from the packet voice/video gateway 232 in conjunction with the style sheet.

FIG. 10g represents an exemplary display of a single video image on the touch panel 72. The display will include a control to return to the status page which, when activated, will cause the subscriber station 24 to return to the display of FIG. 10f. The display includes an indication 524 that the communication with the displayed person is secure.

The display will also include a scroll video control 530 which, when activated will cause the subscriber station 24 to report such activation to the web server 230. The web server 230 performs the steps discussed with respect to FIG. 9 with the selected image scrolled by one video image.

The display will also include a ¼ video control 528 which, when activated will cause the subscriber station 24 to report such activation to the web server application 230. The web server application 230 will perform the steps discussed with respect to FIG. 9 but the packet voice/video gateway 232 will provide a mixed video image comprising each of four video images arranged in the four corners of the display as represented by FIG. 10h.

From any of the displays associated with the conference call (e.g. FIG. 10e, FIG. 10f,

FIG. 10g, and FIG. 10h, termination of the call will cause the subscriber station 24 to return to the main menu as represented by FIGS. 10a or 10b.

The systems and methods of the invention provide enhanced conference call services to subscribers of the multimedia communication management system of the invention. Although the invention has been shown and described with respect to certain preferred embodiments, equivalents and modifications will occur to others skilled in the art upon the reading and understanding of the specification. Those skilled in the art may envision other processing states, events, and processing steps to further the objectives of the modular multi-media communication management system of the invention. The invention includes all such equivalents and modifications, and is limited only by the scope of the following claims.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. For example, modules for encryption, such as for storing public encryption keys, may be disposed in the subscriber's device 50, the subscriber station 24, or the control unit 12. Further, indicia that communications are secure may be provided by a module in the subscriber station 24 instead of by the mix module 238 of the controller 12.

What is claimed is:

1. A communication management system for joining a wireless audio session supported by a wireless communication device into a conference call, comprising:
a control module adapted to couple a plurality of local communication devices in communication on a local network to a plurality of remote communication devices over an external network; and
a subscriber station comprising a control unit adapted to initiate a conference call between said local communication devices and said remote communication devices and further adapted to conference in a wireless communication device into said conference call.

2. A system as claimed in claim 1, wherein the control unit initiates a first VOIP session between the subscriber station and the control module for supporting conference call participation through the subscriber station.

3. A system as claimed in claim 2, wherein the control unit initiates a second VOIP session between the subscriber station and the control module for supporting conference call participation through the wireless communication device.

4. A system as claimed in claim 3, wherein the control module generates a mix signal to each communication device and for the wireless communication device and wherein the mix signal for the wireless communication device is relayed to the subscriber station on the second VOIP session.

5. A conference call system, comprising:
a subscriber station;
a control module coupled to said subscriber station over a first network;
a remote communication device coupled to said control module over a second network;
and
wherein the subscriber station comprises:
a docking station for coupling a wireless communication device;
an audio system;
means for establishing a first VOIP session to the control module, the first VOIP session supporting the exchange of audio data between the audio system and the control module; and
means for establishing a second VOIP session to the control module, the second VOIP session supporting the exchange of audio data between the wireless communication device and the control module.

6. A system as claimed in claim 5, wherein:
the exchange of audio data between the audio system and the control module comprises sending an audio stream representing audio detected by the audio system from the subscriber station to the control module; and
the exchange of audio data between the wireless communication device and the control module comprises sending an audio stream representing audio detected by a remote wireless communication device, and wirelessly communicated to the wireless communication device, from the subscriber station to the control module.

7. A system as claimed in claim 6, wherein:
the exchange of audio data between the audio system and the control module further comprises sending a conference mix audio stream representing at least audio detected by the remote wireless communication device from the control module to the subscriber station for output through the audio system; and
the exchange of audio data between the wireless communication device and the control module comprises sending a conference mix audio stream representing at least audio detected by the audio system from the control module to the subscriber station for coupling to the wireless device, wireless transmission to the remote wireless device, and output through the remote wireless device.

8. A system as claimed in claim 7, wherein the control module comprises conference mix circuitry to communication sessions between said subscriber station, said wireless device and said remote communication device.

9. A system as claimed in claim 5, said subscriber station comprising a controller that includes wireless telephone support circuitry that interfaces with said wireless communication device and said subscriber station.

10. A desk top communication system for participating in a conference session with a remote conferencing server, the desk top communication system comprising:
a network interface for communicating with the conference server;
a docking interface for communicating with a wireless telephone;
an audio system for interfacing audio with a subscriber;
a packet audio circuit for establishing a first communication session with the conference server, the first communication session for exchanging digital audio data between the audio system and the conference server and for establishing a second communication session with the conference server, the second communication session for exchanging digital audio data between the wireless telephone and the conference server.

11. The desk top communication system of claim 10, wherein the communications between the packet audio circuit and the wireless telephone comprise tagged messages.

12. The desk to communication system of claim 10, wherein the communications between the packet audio circuit and the wireless telephone comprises a VOIP session.

13. A method for joining a wireless audio session supported by a wireless communication device into a conference call, the method comprising:
establishing a first communication session between a subscriber station and a conference server, the first communication session supporting participation in the conference call by a subscriber at the subscriber station;
coupling a wireless telephone to the subscriber station;
establishing a second communication session between the subscriber station and the conference server, the second communication session supporting participating in the conference call by a remote participant using a second wireless telephone linked to the wireless telephone by a wireless telephone session.

14. The method of claim 13, wherein the step of establishing a first communication session and the step of establishing a second communication session include establishing a packet audio sessions over a packet switched network.

15. The method of claim 14, wherein the first communication session comprises sending digital audio data received from an audio system from the subscriber station to the conference server and sending a mix signal representing digital audio data of at least one other conference participant from the conference server to the subscriber station for output through the audio system.

16. The method of claim 15, wherein the second communication session comprises sending digital audio data received from the wireless telephone from the subscriber station to the conference server and sending a mix signal representing digital audio data of at least one other conference participant from the conference server to the subscriber station for coupling to the wireless telephone.

17. A method for joining a remote caller to a subscriber's wireless telephone into a conference call supported by a conference server in which the subscriber is participating from a subscriber station, the method comprising:
docking the subscriber's wireless telephone to the subscriber station at which the subscriber is participating in the conference call;
establishing a communication link with the subscriber's wireless telephone such that audio may be interfaced between the subscriber station and the remote caller through the wireless telephone;
establishing a communication session between the subscriber station and the conference server;
relaying audio between the conference server and the wireless telephone.

18. The method of claim 17, further comprising:
establishing a second communication session between the subscriber station and the conference server and relaying audio between the conference server and an audio system in the subscriber station.

19. The method of claim 17, wherein the step of establishing a communication link with the subscriber's wireless telephone comprises establishing a link for the transfer of tagged messages.

20. The method of claim 17, wherein the step of establishing a communication link with the subscriber's wireless telephone comprises establishing a VOIP session.

21. A conference call method, comprising the steps of:
establishing a first audio session between a first and second participant;
detecting a wireless communications device; and
establishing a second audio session between said wireless communication device and said first or second participant.

22. A method as claimed in claim 21, further comprising the step of:
interfacing between said wireless communication device and said second audio session.

23. A method as claimed in claim 22, further comprising the step of:
mixing said first and second audio sessions to permit communication between said first and second participants and said wireless communication device.
